(19) United States
(12) Patent Application Publication
(10) Pub. No.: US 2024/0364579 A1
(43) Pub. Date: Oct. 31, 2024

(54) Responding To Trigger Events That Threaten An Operability Of A Cloud Infrastructure

(71) Applicant: Oracle International Corporation, Redwood Shores, CA (US)

(72) Inventors: Eric Peterson, Seattle, WA (US); William Nickolas Moran, Austin, TX (US); Daniel M. Vogel, Seattle, WA (US); Kenneth Richard Fox, Redwood City, CA (US); Benjamin Todd Willey, Lexington, KY (US)

(73) Assignee: Oracle International Corporation, Redwood Shores, CA (US)

(21) Appl. No.: 18/647,971

(22) Filed: Apr. 26, 2024

Related U.S. Application Data
(60) Provisional application No. 63/462,875, filed on Apr. 28, 2023.
(60) Provisional application No. 63/503,143, filed on May 18, 2023.

(51) Int. Cl. H04L 41/0604

(52) U.S. Cl. CPC H04L 41/0627; H04L 41/0609

(57) ABSTRACT

Techniques for responding to a trigger event that threatens an operability of at least a portion of a cloud infrastructure of a cloud environment are disclosed. In response to detecting the occurrence of the trigger event, a system executes a mitigation process for mitigating an effect of the trigger event. The mitigation process includes determining a set of candidate services as candidates for stopping execution of operations in the cloud environment. In addition, the mitigation process generates a ranking of the set of candidate services based on weighting metrics associated with respective service features of the set of candidate services. Further, based on the ranking, the mitigation process selects a service of the set of candidate services and stops execution of operations of the service to at least partially mitigate the effect of the trigger event.

### BENEFIT CLAIMS; RELATED APPLICATIONS; INCORPORATION BY REFERENCE

This application claims the benefit of the following U.S. Provisional Patent Applications, which are hereby incorporated by reference: U.S. Provisional Patent Application Ser. No. 63/462,875, titled “SYSTEM AND METHOD FOR PROVIDING DEDICATED CLOUD ENVIRONMENTS FOR USE WITH A CLOUD COMPUTING INFRASTRUCTURE,” filed Apr. 28, 2023; and U.S. Provisional Patent Application No. 63/503,143, titled “TECHNIQUES FOR VALIDATING AND TRACKING REGION BUILD SKILLS,” filed May 18, 2023.

The following U.S. patent applications are hereby incorporated by reference: U.S. patent application Ser. No. ______, titled “HEALTH METRICS ASSOCIATED WITH CLOUD SERVICES,” filed Apr. 26, 2024; U.S. patent application Ser. No. ______, titled “MANAGING RESOURCE CONSTRAINTS IN A CLOUD ENVIRONMENT,” filed Apr. 26, 2024; U.S. patent application Ser. No. 18/498,964, titled “SKILLS SERVICE CONFIGURED TO MANAGE ASPECTS OF A BUILDING A DATA CENTER,” filed Oct. 31, 2023; U.S. patent application Ser. No. 18/520,103, titled “TRACKING DATA CENTER BUILD DEPENDENCIES WITH CAPABILITIES AND SKILLS,” filed Nov. 27, 2023; and U.S. patent application Ser. No. 18/537,902, titled “TRACKING DATA CENTER BUILD HEALTH,” filed Dec. 13, 2023.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to cloud environments. More particularly, the present disclosure relates to systems and methods for responding to trigger events that threaten an operability of a cloud infrastructure.

### BACKGROUND

A cloud computing environment can be used to provide access to a range of complementary cloud-based components, such as software applications or services, that enable organizations or enterprise customers to operate their applications and services in a highly available hosted environment. The benefits to an organization in moving their application and service needs to a cloud environment include reductions in the cost and complexity of designing, building, operating, and maintaining their own on-premise data center, software application framework, or other information technology infrastructure.

Organizations that utilize a cloud environment may utilize various techniques to monitor the operations and performance of the cloud environment. Cloud operators may monitor the operations and performance of the cloud environment to gain insights into system health, detect operational issues, optimize resource allocation or utilization, and respond to issues that may arise.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for providing a cloud infrastructure environment in accordance with an embodiment.

FIG. 2 further illustrates how a cloud infrastructure environment can be used to provide cloud-based applications or services or services in accordance with an embodiment.

FIG. 3 illustrates an example cloud infrastructure architecture in accordance with an embodiment.

FIG. 4 illustrates another example of a cloud infrastructure architecture in accordance with an embodiment.

FIG. 5 illustrates another example of a cloud infrastructure architecture in accordance with an embodiment.

FIG. 6 illustrates another example of a cloud infrastructure architecture in accordance with an embodiment.

FIG. 7 illustrates how the system can provide dedicated or private label cloud environments for use by tenants or customers of a cloud infrastructure environment in accordance with an embodiment.

FIG. 8 further illustrates the use of private label cloud realms for use by tenants or customers of a cloud infrastructure environment in accordance with an embodiment.

FIG. 9 further illustrates the use of private label cloud realms for use by tenants or customers of a cloud infrastructure environment in accordance with an embodiment.

FIG. 10 illustrates a system for providing access to software products or services in a cloud computing or other computing environment in accordance with an embodiment.

FIGS. 11A-11C illustrate features of a system that includes a cloud infrastructure protection utility in accordance with one or more embodiments.

FIG. 12A illustrates example mappings of services to service features in accordance with one or more embodiments.

FIGS. 12B and 12C illustrate example dependency graphs that include dependencies between service features in accordance with one or more embodiments.

FIGS. 13A and 13B illustrate example weighting metrics for services of a system in accordance with one or more embodiments.

FIGS. 14A and 14B illustrate example operations for protecting a cloud infrastructure from trigger events that threaten an operability of a cloud infrastructure in accordance with one or more embodiments.

FIG. 15 illustrates an example event mitigation interface for responding to trigger events that threaten an operability of a cloud infrastructure of a system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE CLOUD ENVIRONMENTS
3. SYSTEM ARCHITECTURE FOR CLOUD INFRASTRUCTURE PROTECTION
4. EXAMPLE WEIGHTING METRICS
5. EXAMPLE OPERATIONS FOR CLOUD INFRASTRUCTURE PROTECTION
6. EXAMPLE EVENT MITIGATION INTERFACE
7. MISCELLANEOUS; EXTENSIONS

### 1. General Overview

One or more embodiments mitigate trigger events that threaten an operability of a cloud infrastructure by executing mitigation processes for mitigating effects of the trigger events. In one example, a system executes a mitigation process that includes stopping execution of one or more services in the cloud environment that are selected from a ranking of candidate services, to at least partially mitigate an effect of the trigger event. The candidate services are ranked based on weighting metrics that reflect the value of respective service features of the candidate services. In one example, the trigger events include large-scale events that have a wide impact on cloud infrastructure, such as widespread service outages associated with overheating components of the cloud infrastructure caused by a heatwave. When cloud infrastructure components are overheating, the temperature of the components correlates to a utilization load on the cloud infrastructure from services executing in the cloud environment. By stopping execution of services in the cloud environment, the trigger event is at least partially mitigated by reducing the utilization load on the cloud infrastructure.

In one example, the system determines the weighting metric for the candidate services based on weights assigned to respective service features of the candidate services. The weight assigned to a service feature may represent a value of the service feature within a given context. Thus, the weighting metric for a particular service represents a combination of the values of the respective service features of the particular service. Additionally, or alternatively, the system may determine a weight for a particular service feature based on an impact that the particular service feature has on one or more downstream service features. A service feature may have a relatively higher weight when the service feature impacts a larger number of downstream service features and/or when the service feature impacts a downstream service feature that itself has a relatively higher weight.

In one example, a user, such as a dedicated or private label cloud (PLC) operator or customer, assigns weights to the service features of respective services deployed in a partition of the cloud environment allocated to an entity that is represented by the user. The weights assigned by the user may represent a relative value of the service features to the entity, for example, in the context of operational aspects performed in the partition of the cloud environment and/or in the context of business activities that depend on operations performed in the partition of the cloud environment. As between different partitions of the cloud environment, different instances of a particular service deployed in the respectively different partitions may have different values Thus, the system may determine what services to stop for a particular partition based at least in part on the value of the services with respect to the particular partition. In one example, the system mitigates trigger events, at least in part, by stopping services that have a relatively lower value as indicated by the weighting metrics for the respective services.

In one example, the weighting metric for a service may represent the health of the service. The system may determine the health of the service based on a mapping between the service and a set of one or more service features of the service that are associated with a detected alarm. Additionally, or alternatively, the system may determine the health of a service based on an impact that service features of the service have on downstream service features. Thus, the system may determine what services to stop a particular partition based at least in part on the health of the services with respect to the particular partition. In one example, the system at least partially mitigates trigger events by stopping services that have a relatively lower health as indicated by the weighting metrics for the respective services.

In one example, the weighting metric for a service may represent a combination of a relative value of the service and a health of the service. The system may determine a relative value of the respective service features of the service and a health metric for the respective service features of the service. In one example, the system mitigates a trigger event, at least in part, by stopping a service based on a combination of the value and the health of the service as indicated by the weighting metrics for the respective services. In one example, the system may stop a service based on a ranking that reflects one or more of the following: a relatively lower value and a relatively lower health, a relatively lower health and a relatively higher value, or a relatively lower value and a relatively higher health. Additionally, or alternatively, the system may avoid stopping services that are healthy and have a relatively higher value.

One or more embodiments include a cloud infrastructure protection utility that collects, processes, and analyzes data generated by various components in a cloud environment. The cloud infrastructure protection utility generates weighting metrics and other information pertaining to trigger events as well as the value, health, performance, or behavior services in the cloud environment. The cloud infrastructure protection utility provides insights into the occurrence of trigger events and the operational status of the cloud environment. These insights enable cloud operators to respond to trigger events that threaten the operability of the cloud infrastructure more effectively, while also keeping relatively higher value services operating during adverse conditions resulting from trigger events. The cloud infrastructure protection utility allows cloud operators to protect the cloud infrastructure while reducing service disruptions to customers.

In one example, a cloud infrastructure provider deploys the cloud infrastructure protection utility and/or the event mitigation interface to a partition, such as a realm, of a cloud environment. The partition may be a PLC realm provisioned for a PLC operator such as a customer that operates as reseller. The cloud infrastructure provider may transfer operation of the partition to the PLC operator or customer after deployment of the cloud infrastructure protection utility. One or more operators may access and utilize the cloud infrastructure protection utility to monitor for the occurrence of trigger events and to respond to trigger events that may arise.

One or more embodiments described in this Specification and/or recited in the claims may not be included in this General Overview section.

### 2. Example Cloud Environments

One or more embodiments provide features associated with cloud environments, including PLC environments. The cloud environments can be utilized, for example, by customers or tenants of a cloud infrastructure provider or reseller, in accessing software products, services, or other cloud offerings.

A cloud computing or cloud infrastructure environment can be used to provide access to a range of complementary cloud-based components, such as software applications or services, that enable organizations or enterprise customers to operate their applications and services in a highly available hosted environment. The benefits to an organization in moving their application and service needs to a cloud infrastructure environment include a reduction in the cost and complexity of designing, building, operating, and maintaining their own on-premise data center, software application framework, or other information technology infrastructure. Organizations that utilize a cloud environment may utilize various operational tools to monitor the operations and performance of the cloud environment.

### Cloud Infrastructure Environments

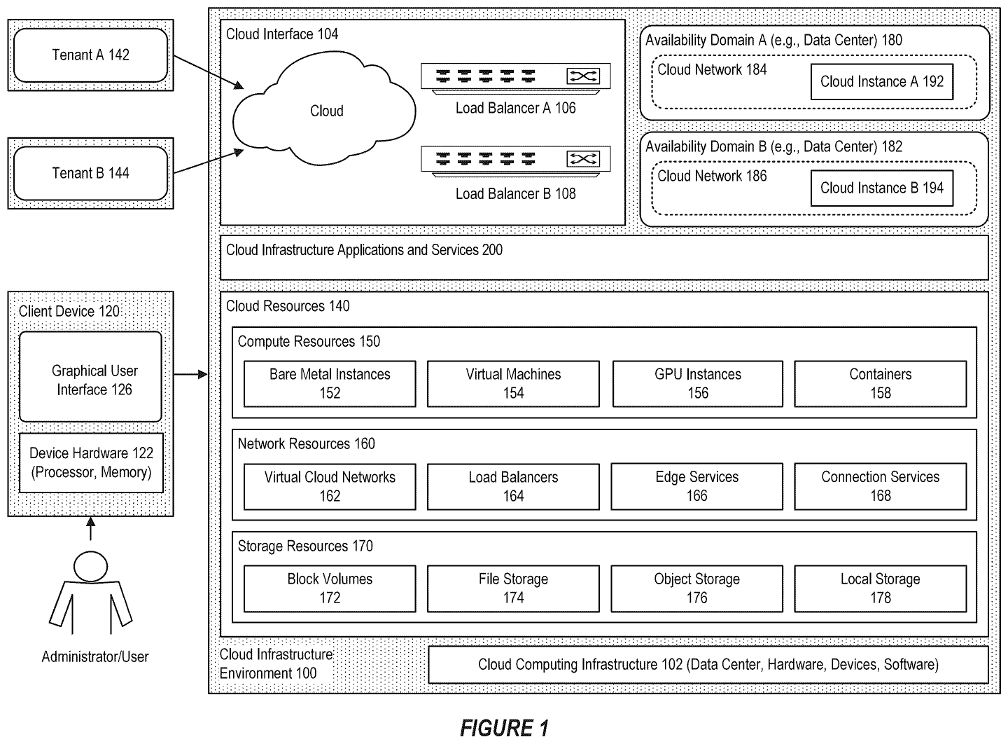

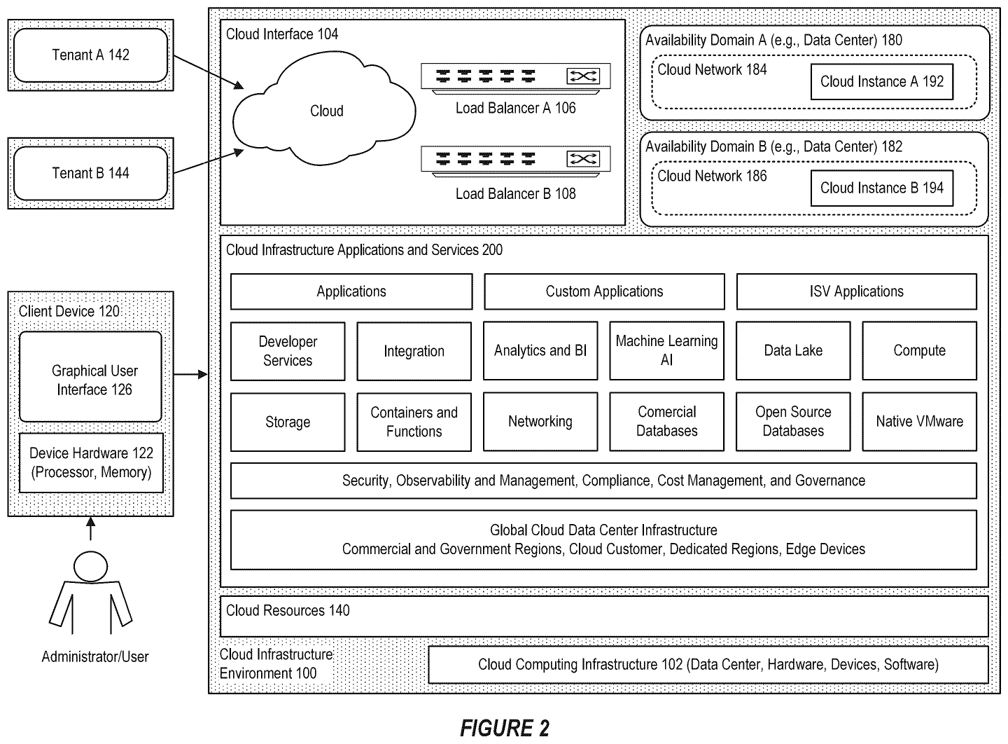

FIGS. 1 and 2 illustrate a system for providing a cloud infrastructure environment in accordance with an embodiment.

In accordance with an embodiment, the components and processes illustrated in FIG. 1, and as further described herein regarding various embodiments, can be provided as software or program code executable by a computer system or other type of processing device, for example, a cloud computing system.

The illustrated example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers A 106, B 108. Cloud interface 102 includes user interfaces and APIs provided by a cloud services provider for interacting with its cloud services. This includes tools and platforms that allow users and administrators to manage, configure, and monitor cloud resources and services. Cloud interface 102 may include a console, such as a web-based user interface that provides a visual way to interact with and manage cloud resources. Through the console, users may, for example, create, configure, and monitor cloud services like compute instances, databases, storage, and networking components. Cloud interface 102 may also include a command line interface for users who prefer to work with the cloud infrastructure using command-line tools. The CLI allows for scripting and automation of cloud management tasks in an embodiment.

In accordance with an embodiment, load balancer A 106 and load balancer B 108 are services that distribute incoming network traffic across multiple servers, instances, or other resources to ensure that no single resource bears too much demand. By spreading the requests evenly across the resources, load balancers enhance the responsiveness and availability of resources such as applications, websites, or databases. Load balancer A 106 and load balancer B 108 may be either public load balancers that are accessible from the Internet and used for distributing external traffic, or private load balancers that are used within a virtual cloud network (VCN) and are not accessible from the public Internet (and are therefore ideal for internal traffic distribution). In an embodiment, load balancer A 106 and load balancer B 108 are designed for high availability and fault tolerance and are implemented in a redundant configuration across multiple availability domains or fault domains.

In accordance with an embodiment, the cloud infrastructure environment supports the use of availability domains, such as availability domain A 180 and availability domain B 182, that enable customers to create and access cloud networks 184, 186, and run cloud instances A 192, B 194. In an embodiment, availability A 180 and availability domain B 182 may represent a data center, or a set of data centers located within a region. These availability domains may be isolated from each other, meaning that they may not share the same physical infrastructure such as power or cooling systems. This design provides a high degree of failure independence and robustness. In an embodiment, a fault domain may provide additional protection and resiliency within a single availability domain by grouping hardware and infrastructure within an availability domain that is isolated from other fault domains. This isolation may be in terms of electricity, cooling, and other potential sources of failure.

In accordance with an embodiment, a tenancy (a container for resources used by a tenant) can be created for each cloud tenant/customer, for example, tenant A 142, B 144, that provides a secure and isolated partition within the cloud infrastructure environment where the customer can create, organize, and administer their cloud resources. A cloud tenant/customer can access an availability domain and a cloud network to access each of their cloud instances. A tenancy in is isolated from other tenancies, ensuring that each customer's data and resources are secure and inaccessible to others. Within a tenancy, customers can create, manage, and organize a wide range of cloud resources, including compute instances, storage volumes, and networks. In Identity and Access Management (IAM) service enables the management of users, groups, and policies within a tenancy. Through IAM, customers can control who has access to their resources and what actions they can perform. The tenancy is also the level where billing and subscription management are handled. Usage and costs associated with the resources within a tenancy are tracked and billed collectively under that tenancy. Each tenancy may be associated with specific service limits and quotas for various resources. These limits may be used to help manage capacity and facilitate resource distribution across each tenant.

In accordance with an embodiment, a computing device, such as a client device 120 having a device hardware 122 (e.g., processor, memory) and graphical user interface 126, can enable an administrator or other user to communicate with the cloud infrastructure environment via a network, such as a wide area network, a local area network, or the Internet, to create or update cloud services.

In accordance with an embodiment, the cloud infrastructure environment provides access to shared cloud resources 140 via, for example, a compute resources layer 150, a network resources layer 160, and/or a storage resources layer 170. Customers can launch cloud instances as needed to meet compute and application requirements. After a customer provisions and launches a cloud instance, the provisioned cloud instance can be accessed from a client device such as client device 120.

In accordance with an embodiment, compute resources 150 can comprise resources, such as bare metal cloud instances 152, virtual machines 154, graphical processing unit (GPU) compute cloud instances 156, and/or containers 158. A bare metal instance represents a physical server with dedicated hardware that is fully allocated to a single tenant. A bare metal instance provides direct access to the server's processor, memory, storage, and other hardware resources. A virtual machine (VM) is a software emulation of a physical computer that runs an operating system and applications like a physical computer. VMs allow multiple operating systems to run on a single physical machine or across multiple machines. A hypervisor layer resides between the hardware and the virtual machines, allocating physical resources (like CPU, memory, and storage) to each VM. In an embodiment, GPU compute cloud instances provide GPUs along with traditional CPU resources. These instances are designed for tasks that require significant parallel processing power, making them ideal for applications like machine learning, scientific computing, 3D rendering, and video processing. In an embodiment, Containers 158 use a method of virtualization that allows for the running of multiple isolated applications on a single control host, virtualizing the operating system. Each container shares the host system's kernel but runs in an isolated user space, making containers lightweight and efficient.

The components of the compute resources 150 can be used to provision and manage bare metal compute cloud instances or provision cloud instances as needed to deploy and run applications, as in an on-premises data center. For example, in accordance with an embodiment, the cloud infrastructure environment can provide control of physical host (bare metal) machines within the compute resources layer that run as compute cloud instances directly on bare metal servers without a hypervisor.

In accordance with an embodiment, the cloud infrastructure environment can also provide control of virtual machines within the compute resources layer that can be launched, for example, from an image, wherein the types and quantities of resources available to a virtual machine cloud instance can be determined, for example, based upon the image that the virtual machine was launched from.

In accordance with an embodiment, the network resources layer can comprise several network-related resources, such as virtual cloud networks (VCNs) 162, load balancers 164, edge services 166, and/or connection services 168. In an embodiment, a virtual cloud network (VCN) is a customizable and private network in a cloud environment. A VCN provides a virtual version of a traditional network, including subnets, route tables, and gateways. It allows users to set up their cloud-based network architecture according to their requirements. In an embodiment, edge services 166 include services and technologies designed to bring computation, data storage, and networking capabilities closer to the location where they are needed. Edge services 166 may be used to optimize traffic, reduce latency, or provide other advantages.

In accordance with an embodiment, the storage resources layer can comprise several resources, such as data/block volumes 172, file storage 174, object storage 176, and/or local storage 178. Data/block volumes 172 provide unformatted block-level storage that can be used to create file systems that host databases or for other purposes requiring unformatted storage. File storage 174 provides a file system in an embodiment and may offer shared file systems that multiple instances can access concurrently using standard file storage protocols. Object storage 176 manages data as objects within storage buckets. Objects have certain attributes that may include data, metadata, and a unique identifier. Local storage 178 refers to storage devices that are physically attached to the host computer.

As illustrated in FIG. 2, in accordance with an embodiment, the cloud infrastructure environment can include a range of complementary cloud-based components, such as cloud infrastructure applications and services 200, that enable organizations or enterprise customers to operate their applications and services in a highly available hosted environment.

In accordance with an embodiment, a self-contained cloud region can be provided as a complete, e.g., Oracle Cloud Infrastructure (OCI), dedicated region within an organization's data center that offers the data center operator the agility, scalability, and economics of an e.g., OCI public cloud, while retaining full control of their data and applications to meet security, regulatory, or data residency requirements.

For example, in accordance with an embodiment, such an environment can include racks physically and logically managed by a cloud infrastructure provider (e.g., Oracle), customer's racks, access for cloud operations personnel for setup and hardware support, customer's data center power and cooling, customer's floor space, an area for customer's data center personnel, and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's (e.g., Oracle's) public cloud regions, for example, ERP, Financials, HCM, and SCM. A customer can seamlessly lift and shift legacy workloads using the cloud infrastructure provider's services (e.g., bare metal compute, VMs, and GPUs), database services (e.g., Oracle Autonomous Database), or container-based services (e.g., Oracle Container Engine for Kubernetes).

In accordance with an embodiment, a cloud infrastructure environment can operate according to an infrastructure-as-a-service (IaaS) model that enables the environment to provide virtualized computing resources over a public network (e.g., the Internet)

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components; example services include billing software, monitoring software, logging software, load balancing software, or clustering software. Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not, be a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries or daemons). This is often managed by the cloud infrastructure provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like).

In accordance with an embodiment, IaaS provisioning may refer to acquiring computers or virtual hosts for use and installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on others, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various geographic locations). However, in some examples, the infrastructure where the code will be deployed requires provisioning. In some instances, the provisioning can be done manually, a provisioning tool may be utilized to provision the resources, and/or deployment tools may be utilized to deploy the code once the infrastructure is provisioned.

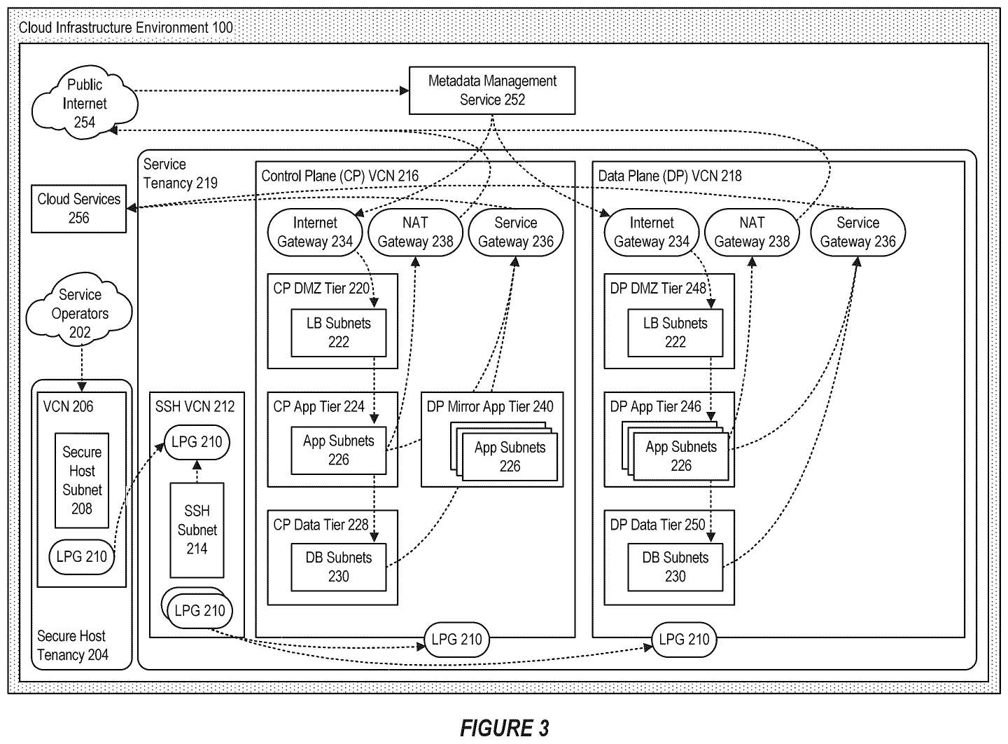

FIG. 3 illustrates an example cloud infrastructure architecture in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices that may be portable handheld devices (e.g., a telephone, a computing tablet, a personal digital assistant (PDA)) or wearable devices (e.g., a head mounted display), running software such as Microsoft Windows, and/or a variety of mobile operating systems, such as IOS, Android, and the like, and being Internet, e-mail, short message service (SMS), or other communication protocol enabled. Alternatively, the client computing devices can be general purpose personal computers including, for example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems such as Chrome OS. Additionally, or alternatively, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnets 222, a control plane app tier 224 that can include app subnets 226, and a control plane data tier 228 that can include database (DB) subnets 230 (e.g., frontend DB subnet(s) and/or backend DB subnet(s)). The LB subnet(s) contained in the control plane DMZ tier can be communicatively coupled to the app subnet(s) contained in the control plane app tier and to an Internet gateway 234 that can be contained in the control plane VCN. The app subnet(s) can be communicatively coupled to the DB subnet(s) contained in the control plane data tier, a service gateway 236, and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier, a data plane DMZ tier, and a data plane data tier. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way; the service gateway can make API calls to cloud services, and cloud services can send requested data to the service gateway. Generally, cloud services may not initiate API calls to the service gateway.

In accordance with an embodiment, the secure host tenancy can be directly connected to the service tenancy that may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example, create, read, update, or delete (CRUD) operations through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both that may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage that may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy that may be isolated from the public Internet.

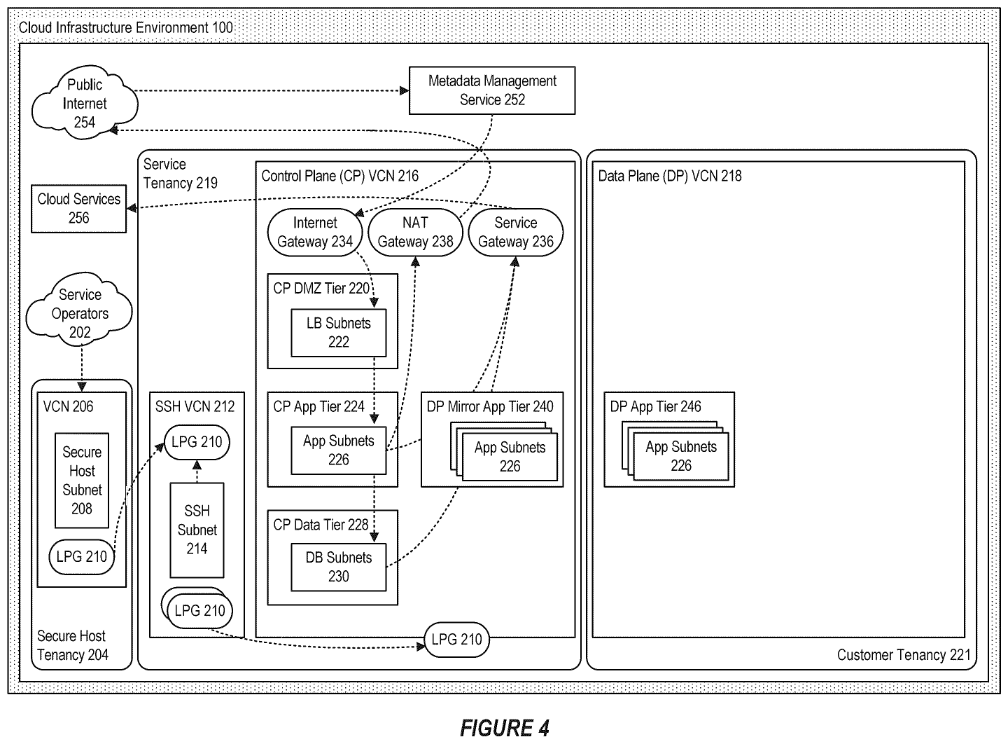

FIG. 4 illustrates another example of a cloud infrastructure architecture in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources provisioned in the control plane VCN contained in the service tenancy to be deployed or otherwise used in the data plane VCN contained in the customer tenancy.

In accordance with an embodiment, a customer of the cloud infrastructure provider may have databases that are managed and operated within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but the data plane mirror app tier may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, by the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with, Deployment 1 in Region 2.

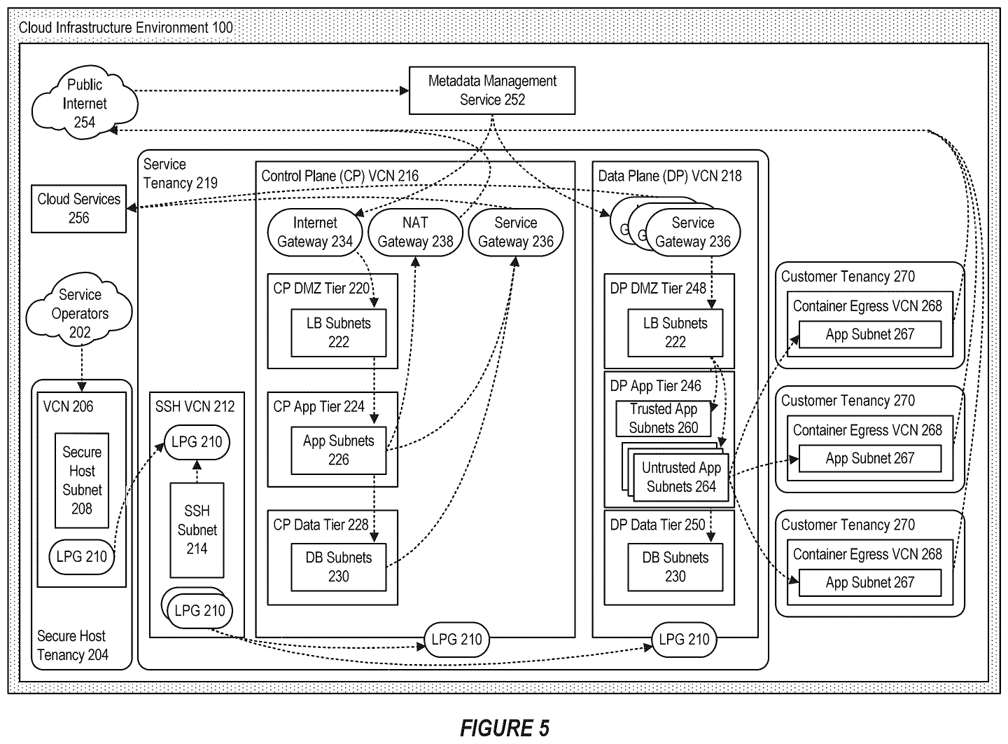

FIG. 5 illustrates another example of a cloud infrastructure architecture in accordance with an embodiment.

As illustrated in FIG. 5, in accordance with an embodiment, the trusted app subnets 260 can be communicatively coupled to the service gateway contained in the data plane VCN, the NAT gateway contained in the data plane VCN, and DB subnet(s) contained in the data plane data tier. The untrusted app subnets 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)) that may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s) and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled, or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

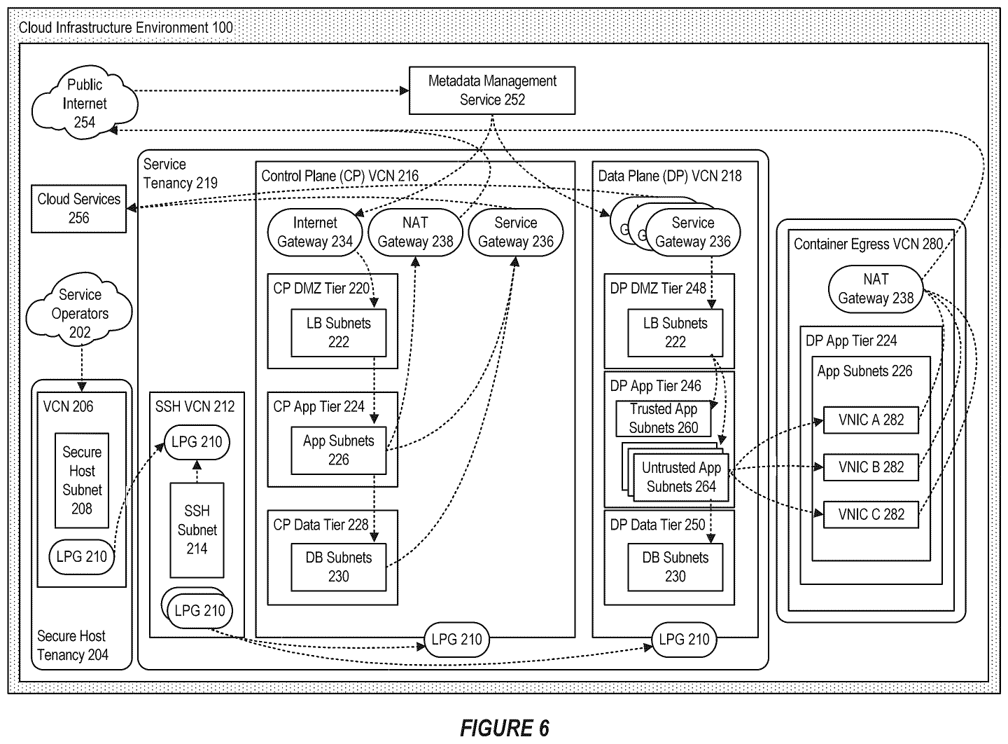

FIG. 6 illustrates another example of a cloud infrastructure architecture in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container and be communicatively coupled to an app subnet that can be contained in a data plane app tier that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that request a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining that the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Private Label Cloud Environments

In accordance with an embodiment, a cloud infrastructure environment can be used to provide dedicated cloud environments, for example, as one or more private label cloud environments for use by tenants of the cloud infrastructure environment in accessing subscription-based software products, services, or other offerings associated with the cloud infrastructure environment.

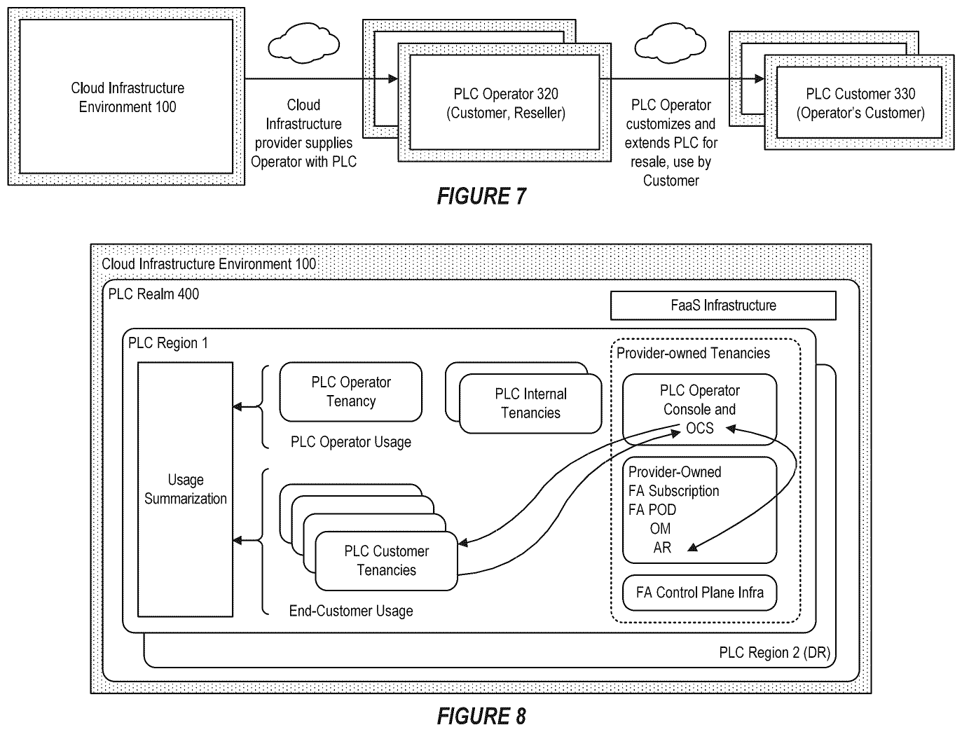

FIG. 7 illustrates how the system can provide dedicated or private label cloud environments for use by tenants or customers of a cloud infrastructure environment in accordance with an embodiment.

As illustrated in FIG. 7, in accordance with an embodiment, a cloud infrastructure provider (e.g., OCI) can supply a PLC operator 320, for example an OCI customer operating as a reseller, with one or more PLC environments. The PLC operator/reseller can then customize and extend the private label cloud for use by (their) customer 330 for use in accessing subscription-based software products, services, or other offerings associated with the cloud infrastructure environment.

For purposes of illustration, examples of such subscription-based products, services, or other offerings may include various Oracle Cloud Infrastructure software products, Oracle Fusion Applications products, or other types of products or services that allow customers to subscribe to usage of those products or services.

FIG. 8 further illustrates the use of private label cloud realms for use by tenants or customers of a cloud infrastructure environment in accordance with an embodiment.

As illustrated in FIG. 8, in accordance with an embodiment, the system can include a cloud subscription service or component, such as an Oracle Cloud Subscriptions (OCS) service or component, that exposes one or more subscription management APIs for creating orders used to onboard new customers or to launch a workflow that creates a subscription and orchestrates billing and pricing service or other components for use with a PLC realm 400.

In accordance with an embodiment, when a PLC operator or their customer requests a PLC environment, the system creates a PLC realm for use with one or more provider-owned tenancies. A realm is a logical collection of one or more cloud regions that are isolated from each other and do not allow customer content to traverse realm boundaries to a region outside that realm. Each realm is accessed separately. PLC operators access cloud resources and services through a cloud tenancy. A cloud tenancy is a secure and isolated partition of a cloud infrastructure environment, and it only exists in a single realm. Within this tenancy, operators can access services and deploy workloads across all regions within that realm if policies allow.

In accordance with an embodiment, a first step in the process is to create an operator tenancy for the PLC operator before the realm and associated regions are turned over to them for subsequent management. The PLC operator then becomes the administrator of this tenancy with the ability to view and manage everything that happens within that realm, including their customer accounts and usage by those customers of cloud resources.

Generally, once the realm has been turned over or provided to the PLC operator, the cloud infrastructure provider cannot subsequently access the data within the operator tenancy unless the operator authorizes the cloud infrastructure provider to do so, for example, to provide troubleshooting for issues that may arise.

In accordance with an embodiment, the PLC operator can then create additional internal tenancies, intended for their own use internally, for example, to assess what the end customer experience will be, to provide a sales demo tenancy, or to operate a database for their own internal use. The operator can also create one or more customer tenancies that the end customer will be the administrator for. Cloud infrastructure usage metrics, for example, compute usage, storage usage, and usage of other infrastructure resources, may be consolidated by the operator, reflecting both operator usage and customer usage. Cloud infrastructure usage may be reported to the cloud infrastructure provider.

In accordance with an embodiment, a user interface or console can be provided that allows the PLC operator to manage its customer accounts and customer-offered services. A cloud infrastructure provider can also use a cloud infrastructure tenancy, for example, a Fusion Applications tenancy, to install any needed infrastructure services for use by the operator and their customers.

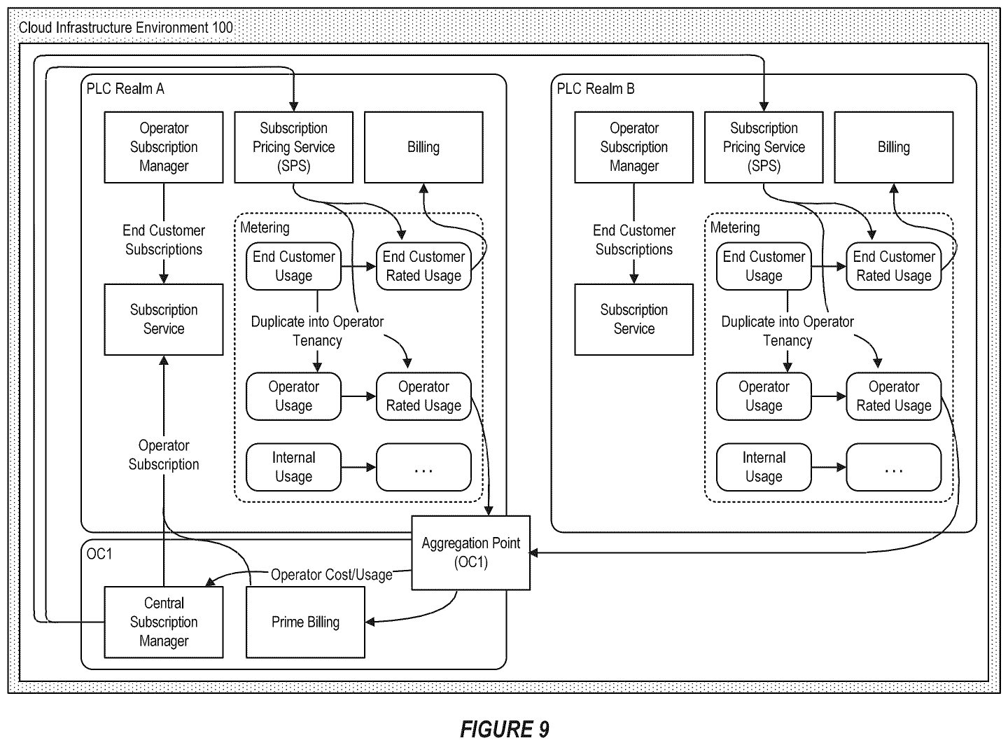

FIG. 9 further illustrates the use of private label cloud realms for use by tenants or customers of a cloud infrastructure environment in accordance with an embodiment.

As illustrated in FIG. 9, in accordance with an embodiment, a cloud subscription service or component exposes one or more subscription management APIs for creating orders used to onboard new customers or to launch a workflow that creates a subscription and orchestrates billing and pricing services or other components.

In accordance with an embodiment, the system can also include a billing service or component that operates upon a billing account or logical container of subscriptions and preferences used to produce an invoice for a customer.

In accordance with an embodiment, the system can also include a subscription pricing service (SPS) or component that operates upon a product catalog that defines the products that can be purchased by a customer. The subscription pricing service can also be used to provide a price list (e.g., a rate card) that the pricing service also owns.

In accordance with an embodiment, to support the sales process used to create a subscription in a PLC realm, products can be selected from a product hub. Once an order is created, a subscription is created in cloud subscription service that thereafter manages the life cycle of that subscription and provisions what needs to be provisioned in downstream services. The SPS component then manages the aspects of pricing and usage for use in charging the end cost to the PLC operator or their ability to charge their customers. Usage events are forwarded to the billing service or component, where, depending on the billing preferences of the subscription, invoices are created and pushed to an accounts receivables component.

In accordance with an embodiment, although the services that are offered in a realm report their usage to a metering service or component, such usage does not have any price associated with it. A rating process determines how much each specific event costs, for example, by applying rate cards, determines a unit and cost for that subscription, associates the cost to that record, and then forwards that to the billing service or component.

As further illustrated in FIG. 9, in accordance with an embodiment, a PLC operator may control multiple realms A, B. For, example an operator that operates in multiple countries may wish to operate a data center that is completely isolated for the United States of America and a separate data center that is completely isolated for Europe, for example, to address governance or regulatory requirements. In accordance with an embodiment, the usage associated with these multiple realms can be aggregated for use in billing the operator.

The examples of various systems illustrated above are provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Private Label Cloud Subscriptions

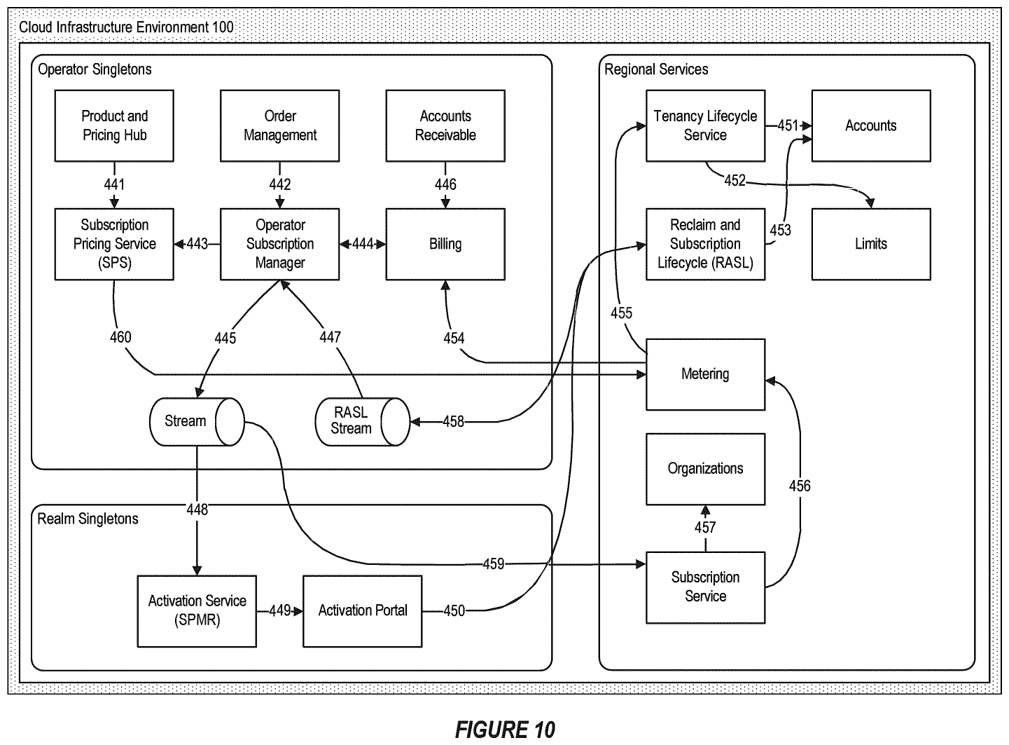

FIG. 10 illustrates a system for providing access to software products or services in a cloud computing or other computing environment in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various Oracle Cloud Infrastructure (OCI) software products, Oracle Fusion Applications products, or other types of products or services that allow customers to subscribe to usage of those products or services.

In accordance with an embodiment, a subscription can include artifacts, such as products, commits, billing model, and state. The cloud subscription service can expose one or more subscription management APIs for creating orders used to onboard new customers or to launch a workflow that creates a subscription and orchestrates creating the proper footprints in billing and pricing service or components as further described below.

In accordance with an embodiment, the billing service or component operates upon a billing account or logical container of subscriptions and preferences used to produce an invoice. Each billing account generates one or more invoices per billing cycle. The billing service includes a first pipeline that accepts usage and cost from a metering service or component. Usage may be accepted through a REST API or another interface. The billing service writes the usage to a database from which balances may be calculated and aggregated by the billing service or other services. The billing service may include a second pipeline responsible for taking the aggregated usage and commitments and calculating charges over one or more billing intervals.

In accordance with an embodiment, the subscription pricing service (SPS) or component operates upon a product catalog that defines the products that can be purchased by a customer. The product catalog forms the backbone of a price list (i.e., rate card) that the pricing service also owns. Rate cards are modeled as pricing rules on top of public list prices. The pricing service maintains a single price list for each product; new product prices can be added and existing prices changed. The price list has a full history, the latest version being the current rate card. Since some contracts may require a snapshot of the rate card be taken, the pricing service handles this by recording the time a customer's rate card is created and then querying the price list at that time.

In accordance with an embodiment, the SPS or pricing service is responsible for providing information about products, global price lists, and end customer subscription specific price lists and discounts. For example, in accordance with an embodiment, the SPS can synchronize product information from a product hub (e.g., an Oracle Fusion Product Hub) and a global price list from a pricing hub (e.g., an Oracle Fusion Pricing Hub).

In accordance with an embodiment, the cloud subscription service operates as an upstream service to receive new order requests, for example, from an Oracle Fusion Order Management environment. The cloud subscription service can provide subscription information to the SPS service. Subscription details like time of quote, configuration, and subscription type (Commitment, PayG) help SPS to determine an effective base price (Rate Card) for the subscription. The cloud subscription service can also send discounts for subscriptions received, for example, from Oracle Fusion Order Management, that SPS stores as a pricing rule entity.

In accordance with an embodiment, the SPS service runs as a background process to manage a rate cards service or component responsible for generating rate cards for new subscriptions and updating when new price changes occur. The SPS service can expose APIs to access rate cards and pricing rules. A metering in-line rating engine can utilize these APIs to get subscription-specific rate cards and pricing rules using this data for cost calculations.

In accordance with an embodiment, additional SPS components can include, for example, a Pricing/Product Hub Oracle Integration Cloud (OIC) integration component, that allows a PLC operator entity providing subscription-based products, services, or other offerings within the environment to manage their product and price list, for example, as provided by an Oracle Fusion Product Hub and Oracle Fusion Pricing Hub, respectively.

For example, in accordance with such an embodiment, an SPS OIC product integration flow can listen to create/update events in the Product Hub and make calls to an SPS product API. Similarly, an SPS OIC pricing integration flow can pull new price list creations from the Pricing Hub and call respective SPS pricing APIs.

In accordance with an embodiment, the system can also include an SPS core module that provides APIs to manage and access pricing entities. Pricing can be accessed by internal services, such as an inline rating engine.

In accordance with an embodiment, the system can also include a rate card manager component. The SPS service maintains the single base price for a product at a given time. However, product prices for subscriptions are dependent on a base price at quote configuration time and price list change policy attributes of subscriptions. The SPS service internally maintains the price to be used for subscriptions using these properties. Such price lists are grouped in a rate card. The rate card manager can create and maintain the rate card as well as listen to price list changes and update existing rate cards with the new price. It also listens to new subscriptions and assigns the rate card based on subscription properties.

In accordance with an embodiment, the system can also include a rule decoder engine. The SPS service is responsible for managing pricing rules for a subscription, including discounts offered to an end customer. Pricing rules eligibility can be based on attributes of Products, like Discount group, Product Category, or specific SKUs. Internally, SPS needs to identify the list of products these rules will be applicable. To accomplish this, the rule decoder engine can compile the pricing rules in a format such that an in-line rating engine can consume for cost calculation. This compilation process can be triggered when products or pricing rules get created/updated.

As illustrated by way of example in FIG. 10, in accordance with an embodiment: at 441, a product and price information managed in, e.g., Fusion Applications, is sent to the SPS component. At 442, orders are sent to the cloud subscription service component to create subscriptions, rate cards, and billing accounts. At 443, pricing configuration and pricing rules are sent to SPS for new orders. At 444, the cloud subscription service is used to set up a billing account in the billing service or component. At 445, the cloud subscription service publishes events to a cloud infrastructure streaming component. At 446, charge data is sent to an accounts receivable component to generate invoices. At 447, cloud subscription service consumes reclaim and subscription lifecycle (RASL) events from cloud infrastructure streaming. At 448, an activation service reads the cloud subscription service event stream. At 449, a customer gets activation data from a portal. At 450, a tenancy lifecycle service provisions a tenancy as part of the subscription activation. At 451, the tenancy lifecycle service creates an accounts footprint during account provisioning. At 452, the tenancy lifecycle service sets a limits template during account provisioning. At 453, the accounts component acts as a downstream RASL client to handle legacy reclamation. At 454, aggregated cost and usage is sent to the billing service or component. At 455, an organization can create child tenancies using the tenancy lifecycle service. At 456, a metering service or component gets subscription mapping data. At 457, the subscription service gets organization data for subscription mappings. At 458, RASL reads cloud subscription service event stream. At 459, the subscription service reads cloud subscription service event stream; and at 460, the metering service or component gets a rate card data for each subscription that can then be used in charging the end cost to the PLC operator or their ability to charge their customers.

The above example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### 3. System Architecture for Cloud Infrastructure Protection

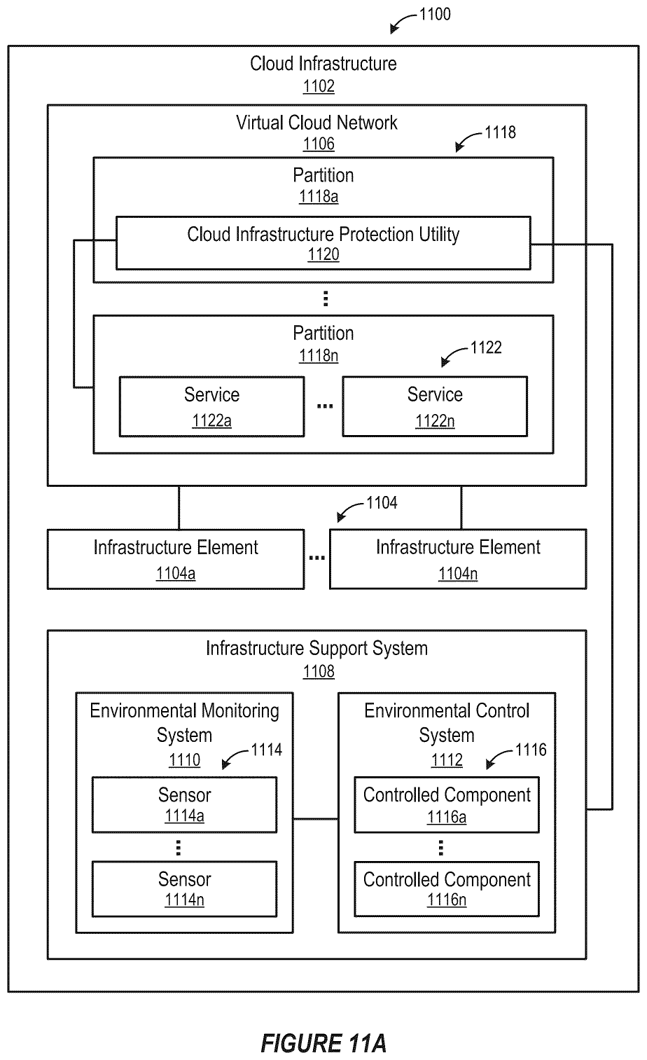

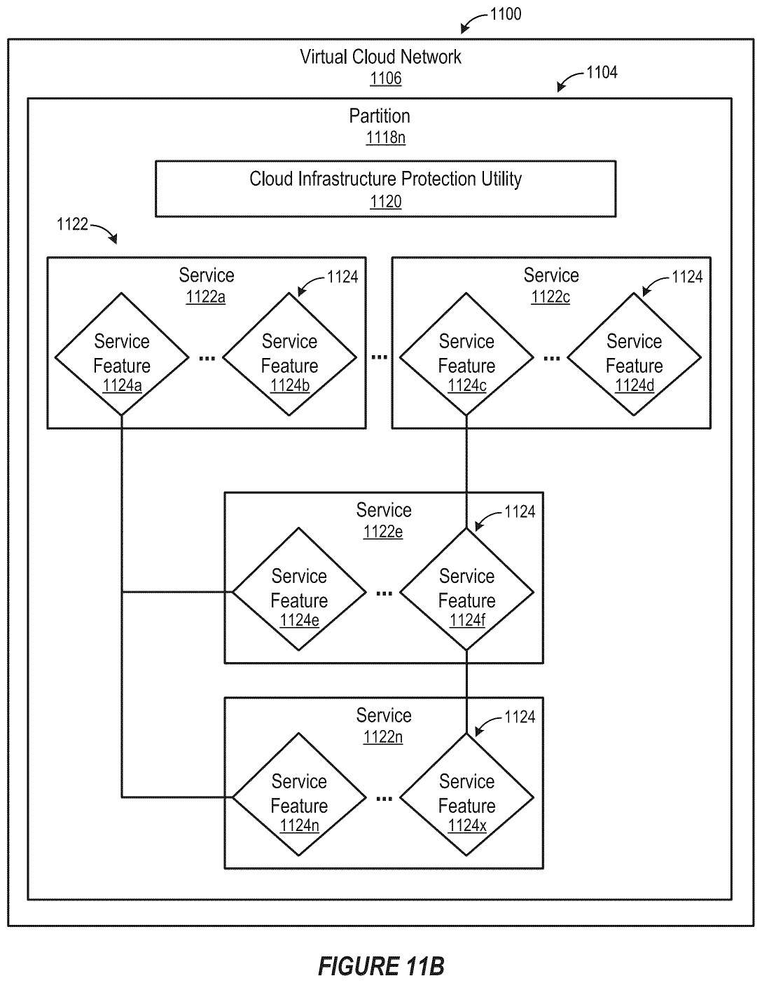

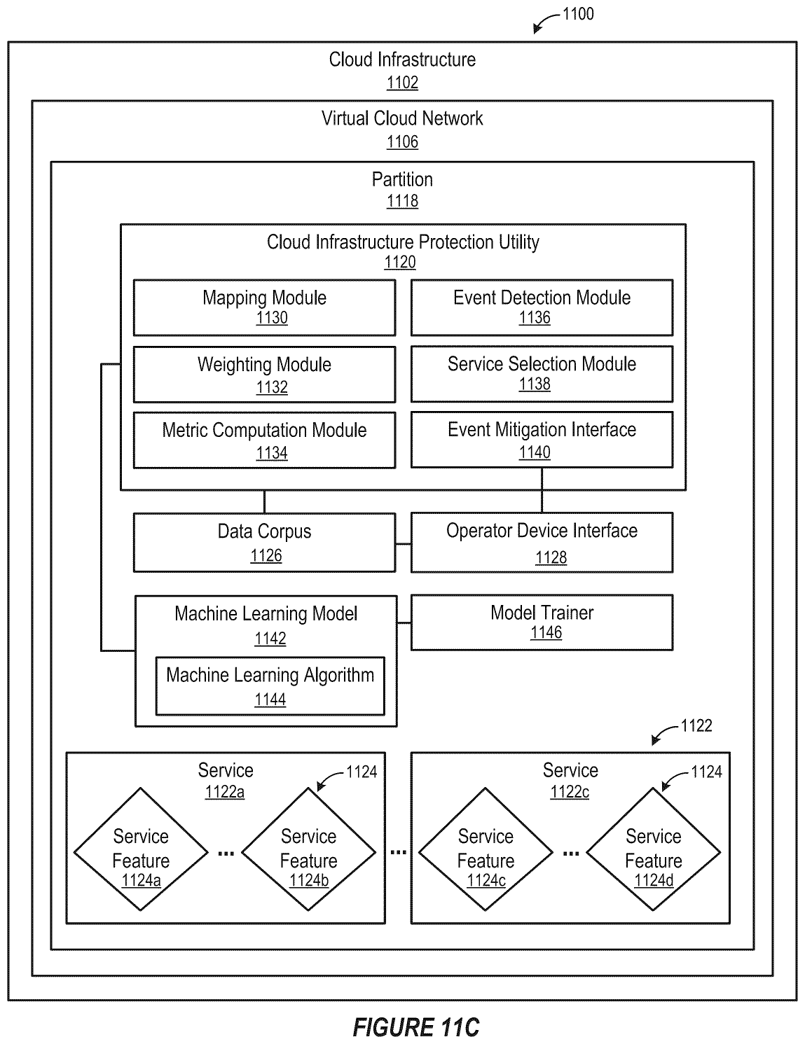

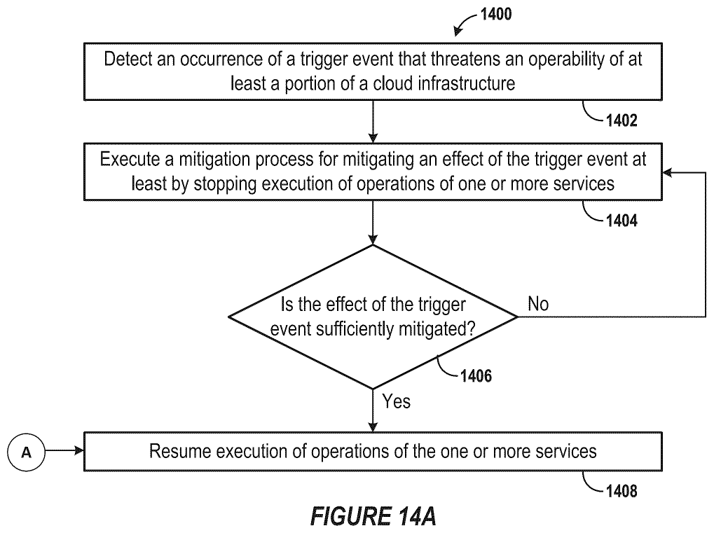

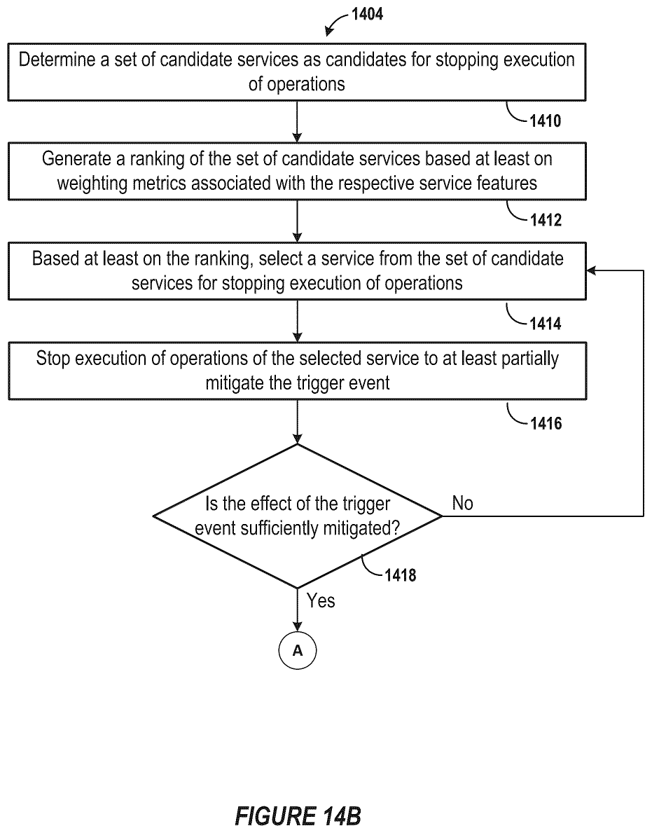

FIGS. 11A-11C illustrate a system 1100 that includes features for cloud infrastructure protection, including features for responding to trigger events that threaten an operability of a cloud infrastructure, in accordance with one or more embodiments. In one or more embodiments, the system 1100 refers to hardware and/or software configured to perform operations described herein. Examples of operations are described below with reference to FIGS. 14A and 14B. In addition to the features described with reference to FIGS. 11A-11C, the system 1100 may include one or more features described above in Section 2, titled “Dedicated Or Private Label Cloud Environments.”

In one or more embodiments, the system 1100 may include more or fewer components than the components described with reference to FIGS. 11A-11C. The components described with reference to FIGS. 11A-11C may be local to or remote from each other. The components described with reference to FIGS. 11A-11C may be implemented in software and/or hardware. The components of system 1100 may be distributed over multiple applications and/or machines. Multiple components may be combined into one application and/or machine. Operations described with respect to one component may instead be performed by another component.

### A. Example Trigger Event Monitoring

Referring to FIG. 11A, the system 1100 includes a cloud infrastructure 1102. The cloud infrastructure 1102 includes infrastructure elements 1104, a virtual cloud network 1106, and an infrastructure support system 1108. The infrastructure elements 1104, such as infrastructure element 1104a and infrastructure element 1104n, include physical components that are utilized to provide a cloud infrastructure environment. As examples, the physical components may include one or more of the following: servers, racks, switches, processors, memory devices, storage devices, networking devices, power supply devices, and other physical components that are utilized to provide the cloud infrastructure environment. The virtual cloud network 1106 is deployed on at least a portion of the infrastructure elements 1104.

The infrastructure support system 1108 includes an environmental monitoring system 1110 that monitors environmental conditions associated with the system 1100 and an environmental control system 1112 that controls environmental conditions associated with the system 1100. The environmental monitoring system 1110 includes multiple sensors 1114, such as sensor 1114a and sensor 1114n. The sensors 1114 may monitor environmental conditions, for example, to detect environmental conditions that may be indicative of a trigger event. The environmental conditions monitored by the sensors 1114 may include one or more of the following: temperature, humidity, barometric pressure, moisture, water, wind speed, smoke, or air quality. In one example, a sensor 1114 includes one or more of the following: a temperature sensor, a humidity sensor, a barometric pressure sensor, a moisture sensor, a flood sensor, an anemometer, a smoke detector, or an air quality sensor. Additionally, or alternatively, the sensors 1114 may monitor operating conditions of the cloud infrastructure 1102, for example, to detect operating conditions that may be indicative of a trigger event. The operating conditions monitored by the sensors 1114 may include one or more of the following: power consumption, voltage, network traffic, latency, virtualization performance, storage performance, database performance, server workload, load balancer health, or application performance.

The environmental control system 1112 includes multiple controlled components 1116, such as controlled component 1116a and controlled component 1116n. The environmental control system 1112 controls the controlled components 1116 to adjust environmental parameters that may impact the cloud infrastructure. The controlled components 1116 may include one or more of the following: heating systems, cooling systems, ventilation systems, air conditioning systems, fans, blowers, dampers, vents, humidification systems, dehumidification systems, fire suppression systems, air quality control devices, or lighting systems. The environmental control system 1112 may control the controlled components 1116 in response to control commands from the environmental monitoring system 1110. The control commands may cause the controlled components 1116 to operate in a manner that provides desired environmental conditions for infrastructure elements 1104 of the cloud infrastructure 1102 and/or the virtual cloud network 1106 deployed on the infrastructure elements 1104. In one example, the controlled components 1116 maintain temperature and humidity levels, for example, to prevent overheating of the infrastructure elements 1104 and/or to sustain reliable operations of the infrastructure elements 1104. The sensors 1114 may monitor operations of the controlled components 1116, for example, to provide feedback to the environmental control system 1112 corresponding to the control commands. Additionally, or alternatively, the sensors 1114 may monitor operations of the infrastructure elements 1104, for example, to validate that the infrastructure elements 1104 are performing nominally and/or to detect occurrences of outages, disruptions, anomalies, or performance deficiencies.

Referring further to FIG. 11A, multiple partitions 1118 are deployed on the virtual cloud network 1106, such as partition 1118a and partition 1118n. The partitions 1118 represent logically or physically isolated portions of the virtual cloud network 1106. In one example, the partitions 1118 include tenant partitions, or tenancies, that isolate portions of the virtual cloud network 1106 as between different entities, or tenants, such as PLC operators or customers. Additionally, or alternatively, the partitions 1118 may include service partitions that isolate different services or workloads. Additionally, or alternatively, the partitions 1118 may include geographic partitions that isolate a portion of the virtual cloud network 1106 corresponding to a particular geographic region. Additionally, or alternatively, the partitions 1118 may include network partitions that isolate the virtual cloud network 1106 into separate segments or subnets.

One more of the partitions 1118 include a cloud infrastructure protection utility 1120. Additionally, or alternatively, one or more partitions 1118 include multiple services 1122, such as service 1122a and service 1122n. The cloud infrastructure protection utility 1120 may execute operations pertaining to protecting the cloud infrastructure 1102, including detecting trigger events that threaten an operability of the cloud infrastructure 1102 and/or executing mitigation processes for mitigating effects of trigger events. In one example, the mitigation processes may include stopping execution of operations of one or more services 1122.

The cloud infrastructure protection utility 1120 may stop services 1122 that are executing in one or more partitions 1118 of the virtual cloud network 1106 in response to a trigger event. The services 1122 that are stopped to mitigate an effect of the trigger event may be located in the same partition as the cloud infrastructure protection utility 1120 and/or in a different partition 1118 from the cloud infrastructure protection utility 1120. In one example, as shown in FIG. 11A, partition 1118a includes a cloud infrastructure protection utility 1120, and partition 1118n includes multiple services 1122 that may be stopped by the cloud infrastructure protection utility 1120 to mitigate an effect of a trigger event.

In one example, a cloud infrastructure protection utility 1120 is deployed to a partition 1118 allocated to a cloud operator, such as a PLC operator or a customer, and the cloud operator utilizes the cloud infrastructure protection utility 1120 to detect trigger events and to stop services 1122 that are executing in the partition 1118 to at least partially mitigate an effect of the trigger event. Additionally, or alternatively, multiple different cloud operators, such as multiple different PLC operators or customers, may respectively utilize an instance of the cloud infrastructure protection utility 1120 to detect trigger events in their respective partitions 1118. The trigger events may be at least partially mitigated by stopping services 1122 that are executing in their respective partition 1118. Multiple partitions 1118 where services 1122 are stopped may collectively contribute to mitigating an effect of the trigger event. Additionally, or alternatively, a cloud infrastructure protection utility 1120 may be deployed to a partition 1118 allocated to a cloud infrastructure provider that monitors various partitions 1118 of the virtual cloud network 1106. The cloud infrastructure provider may utilize the cloud infrastructure protection utility 1120 to detect trigger events and to stop services 1122 that are executing in various partitions 1118 to at least partially mitigate an effect of the trigger event. In one example, the cloud infrastructure provider may utilize the cloud infrastructure protection utility 1120 to select services 1122 to stop executing from among various partitions 1118, such as from among various partitions 1118 allocated to various PLC operators or customers. In one example, the various PLC operators or customers may utilize the cloud infrastructure protection utility 1120 to provide inputs that can be utilized, for example, by the cloud infrastructure provider, to select services 1122 to stop executing to mitigate an effect of a trigger event. The inputs may allow the services 1122 to be stopped in various partitions 1118 based on criteria that is specific to the particular partition 1118 and/or the particular services 1122 executing in the partition 1118.

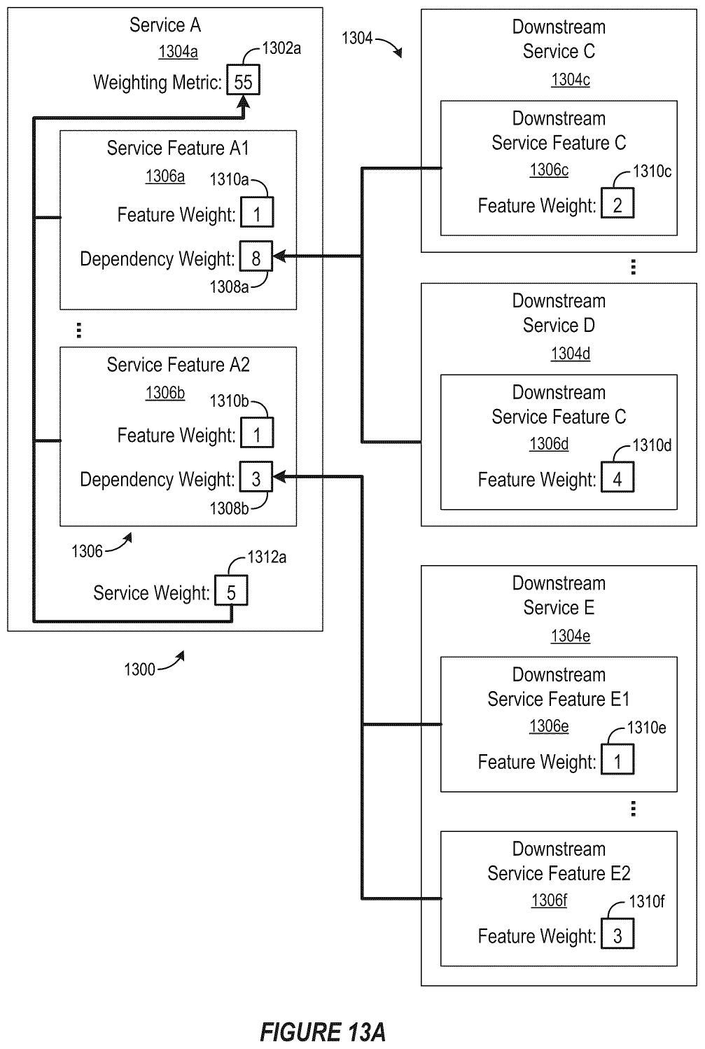

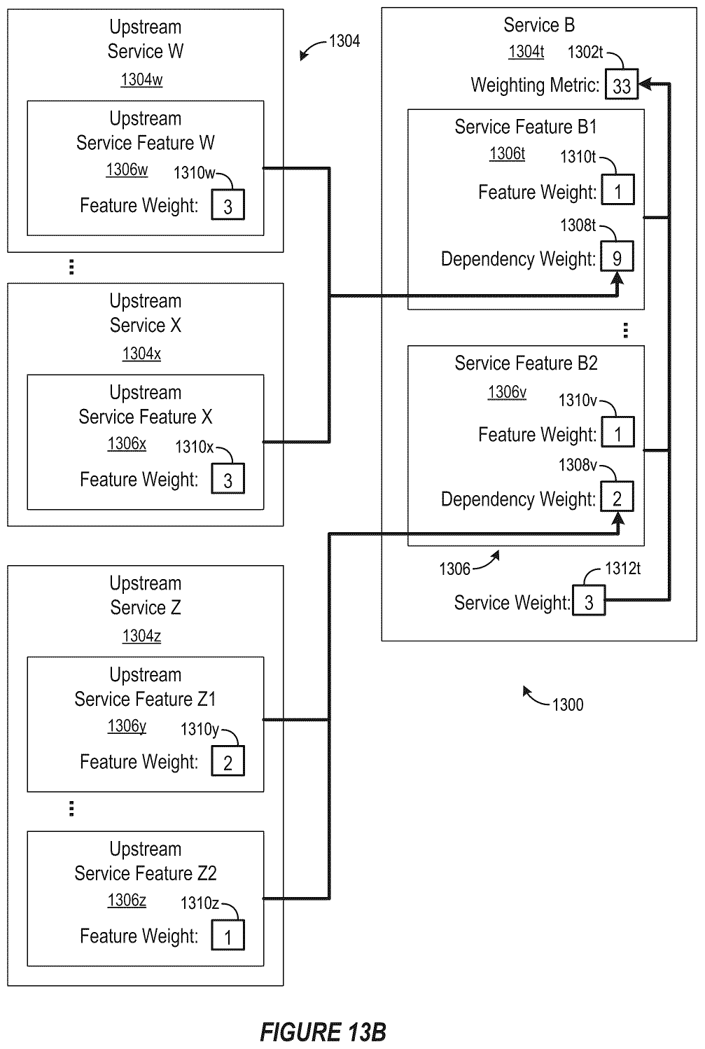

In one example, the inputs may be utilized to compute weighting metrics for various services 1122 that are utilized to determine services 1122 to be stopped to mitigate an effect of a trigger event. In one example, the cloud infrastructure protection utility 1120 determines services 1122 to be stopped based at least on weighting metrics that correspond to weights assigned to respective service features of the services 1122. The weights assigned to the service features may represent values of the service features within a given context. Additionally, or alternatively, the cloud infrastructure protection utility 1120 may monitor the health of the services 1122 and/or service features. In one example, the cloud infrastructure protection utility 1120 selects services 1122 to be stopped based at least on weighting metrics that correspond to the health of services 1122 and/or respective service features of the services 1122. Example services 1122 and service features are further described below with reference to FIG. 11B. Example weighting metrics are further described below with reference to FIGS. 13A and 13B.

As used herein, the term “trigger event” refers to an occurrence of an event or situation that threatens, disrupts, or inhibits an operability of at least a portion of a cloud infrastructure. A trigger event threatens an operability of a portion of a cloud infrastructure when the event or situation has an appreciable likelihood of exceeding an operating parameter corresponding to the respective portion of the cloud infrastructure. The operating parameter may include a control limit or a specification for operating the respective portion of the cloud infrastructure. A trigger event may include a large-scale event or situation that has a wide impact on the cloud infrastructure such as a widespread service outage. Additionally, or alternatively, a trigger event may include an isolated event or situation that impacts an isolated portion of the cloud infrastructure.

A trigger event may be associated with one or more of the following: weather, an environmental condition, an equipment failure or malfunction, operating conditions of a cloud infrastructure, malfeasance, or human error. Additionally, or alternatively, a trigger event may be associated with one or more of the following: severe weather, a heatwave, a storm, a natural disaster, a cold snap, a hurricane, a blizzard, a tornado, a sandstorm, a flood, a fire, a detonation, wind, rain, snow, ice, haze, or smog. Additionally, or alternatively, a trigger event may be associated with one or more of the following: a hardware failure, a power outage, a utilities outage, a transition to a backup power source, a power supply limitation, a brownout, a blackout, a cloud infrastructure outage, a cooling system failure, a ventilation system failure, a heating system failure, a network disruption, a software bug, a cybersecurity incident, a security breach, a system upgrade, or a maintenance event.

In one example, a trigger event may be based on one or more of the following: a threshold, a physical limitation, a performance limitation, a capacity plan, an operating policy, a cost limitation, or an efficiency parameter. A trigger event may be determined by comparing sensor data from the environmental monitoring system 1110 to a threshold. The threshold may correspond to a limit or restriction associated with the operability of at least a portion of the cloud infrastructure 1102. The trigger event and/or the threshold may be selected to prevent or reduce potential damage to the cloud infrastructure. A trigger event associated may be determined with respect to a current, scheduled, or predicted scenario. The scenario may pertain to environmental conditions and/or operating conditions of the cloud infrastructure 1102. A trigger event may be determined with respect to finite deterministic scenarios and/or probabilistic scenarios. In one example, a trigger event may correspond to a scenario that definitively threatens, disrupts, or inhibits an operability of at least a portion of a cloud infrastructure. Additionally, or alternatively, a trigger event may correspond to a scenario that satisfies a probability threshold for threatening, disrupting, or inhibiting an operability of at least a portion of the cloud infrastructure.

### B. Example Services and Service Features

Referring to FIG. 11B, as illustrated with respect to partition 1118n, a partition 1118 includes services 1122, and the services 1122 respectively include one or more service features 1124.

In one example, as shown in FIG. 11B, partition 1118n includes service 1122a and service 1122c. Service 1122a includes service feature 1124a and service feature 1124b. Service 1122c includes service feature 1124c and service feature 1124d. Additionally, partition 1118n includes service 1122e and service 1122n. Service 1122e includes service feature 1124e and service feature 1124f. Service 1122n includes service feature 1124n and service feature 1124x.

The cloud infrastructure protection utility 1120 determines an occurrence of a trigger event. To mitigate an effect of the trigger event on the cloud infrastructure, the cloud infrastructure protection utility 1120 determines a service 1122 from partition 1118n to stop executing based on weighting metrics associated with respective service features 1124 of the services 1122. In one example, the cloud infrastructure protection utility 1120 may determine a service 1122 to stop executing based on a weighting metric for service 1122a that corresponds to weights assigned to service feature 1124a and service feature 1124b of service 1122a. Additionally, or alternatively, the cloud infrastructure protection utility 1120 may determine a service 1122 to stop executing based on a weighting metric for service 1122c that corresponds to weights assigned to service feature 1124c and service feature 1124d of service 1122c. Additionally, or alternatively, the cloud infrastructure protection utility 1120 may determine a service 1122 to stop executing based on a weighting metric for service 1122e that corresponds to weights assigned to service feature 1124e and service feature 1124f of service 1122c. Additionally, or alternatively, the cloud infrastructure protection utility 1120 may determine a service 1122 to stop executing based on a weighting metric for service 1122n that corresponds to weights assigned to service feature 1124n and service feature 1124x of service 1122n.

In one example, the cloud infrastructure protection utility 1120 determines the weighting metric for a service 1122 based on weights assigned to the one or more service features 1124 of the service 1122 that represent values of the respective service features within a given context. Additionally, or alternatively, the cloud infrastructure protection utility 1120 may determine the weighting metric for a service 1122 based on weights assigned to the one or more service features 1124 of the service 1122 that represent impacts that the respective service features 1124 have on one or more other service features 1124 arranged downstream.

As illustrated in FIG. 11B, service feature 1124e of service 1122e is arranged downstream from service feature 1124a of service 1122a. Service feature 1124e depends on service feature 1124a. In one example, a functionality of service feature 1124e depends on a functionality of service feature 1124a. Additionally, service feature 1124n of service 1122n is arranged downstream from service feature 1124a of service 1122a. Service feature 1124n depends on service feature 1124a. In one example, a functionality of service feature 1124n depends on a functionality of service feature 1124a. The functionalities of service feature 1124a may include generating one or more outputs that are utilized as an input by service feature 1124c and/or by service feature 1124n. Additionally, or alternatively, the functionalities of service feature 1124a may include executing one or more operations that directly or indirectly impact service feature 1124e and/or service feature 1124n. Additionally, or alternatively, service feature 1124c and/or service feature 1124n may be arranged subsequent to service feature 1124a with respect to a data flow or a sequence of operations. The cloud infrastructure protection utility 1120 may determine the weighting metric for service 1122a based at least in part on (a) an impact that service feature 1124a has on service feature 1124e as a result of a dependency between service feature 1124a and service feature 1124e and/or (b) an impact that service feature 1124a has on service feature 1124n as a result of a dependency between service feature 1124a and service feature 1124n.

As further illustrated in FIG. 11B, service feature 1124f of service 1122e is arranged downstream from service feature 1124c of service 1122c, and service feature 1124x of service 1122n is arranged downstream from service feature 1124f of service 1122e. Service feature 1124f depends on service feature 1124c. In one example, a functionality of service feature 1124f depends on a functionality of service feature 1124c. The functionalities of service feature 1124c may include generating one or more outputs that are utilized as an input by service feature 1124f and/or executing one or more operations that directly or indirectly impact service feature 1124f. Additionally, or alternatively, service feature 1124f may be arranged subsequent to service feature 1124c with respect to a data flow or a sequence of operations. Additionally, service feature 1124x depends on service feature 1124f. In one example, a functionality of service feature 1124x depends on a functionality of service feature 1124f. The functionalities of service feature 1124f may include generating one or more outputs that are utilized as an input by service feature 1124x and/or executing one or more operations that directly or indirectly impact service feature 1124x. Additionally, or alternatively, service feature 1124x may be arranged subsequent to service feature 1124f with respect to a data flow or a sequence of operations. Additionally, service feature 1124x depends indirectly from service feature 1124c. Service feature 1124c indirectly impacts service feature 1124x. The cloud infrastructure protection utility 1120 may determine the weighting metric for service 1122c based at least in part on an impact that service feature 1124c has on service feature 1124f and/or service feature 1124x. Additionally, or alternatively, the cloud infrastructure protection utility 1120 may determine the weighting metric for service 1122c and/or the weighting metric for service 1122e based at least in part on an impact that service feature 1124f has on service feature 1124x.

In one example, the cloud infrastructure protection utility 1120 may determine the weighting metric for a service 1122 based on weights assigned to the one or more service features 1124 of the service 1122 that represent impacts that one or more service features 1124 arranged upstream have on one or more service features 1124 of the service 1122. As illustrated in FIG. 11B, service feature 1124a of service 1122a is arranged upstream from service feature 1124e of service 1122e and service feature 1124n of service 1122n. Service feature 1124a impacts service feature 1124e as a result of a dependency between service feature 1124a and service feature 1124c. Additionally, or alternatively, service feature 1124a impacts service feature 1124n as a result of a dependency between service feature 1124a and service feature 1124n. The cloud infrastructure protection utility 1120 may determine the weighting metric for service 1122e based at least in part on an impact that service feature 1124a has on service feature 1124c. Additionally, or alternatively, the cloud infrastructure protection utility 1120 may determine the weighting metric for service 1122n based at least in part on an impact that service feature 1124a has on service feature 1124n.

As further illustrated in FIG. 11B, service feature 1124f of service 1122e is arranged upstream from service feature 1124x of service 1122n, and service feature 1124c of service 1122c is arranged upstream from service feature 1124f. Service feature 1124f impacts service feature 1124x as a result of a dependency between service feature 1124f and service feature 1124x. Service feature 1124c impacts service feature 1124f as a result of a dependency between service feature 1124c and service feature 1124f. The cloud infrastructure protection utility 1120 may determine the weighting metric for service 1122e based at least in part on an impact that service feature 1124c has on service feature 1124f. Additionally, or alternatively, the cloud infrastructure protection utility 1120 may determine the weighting metric for service 1122n based at least in part on an impact that service feature 1124f and/or service 1122c have on service feature 1124x.

The term “downstream,” as used herein with reference to an arrangement of a first service feature downstream from a second service features, refers to at least one of the following: (a) the first service feature being arranged subsequent to the second service feature with respect to a data flow or a sequence of operations, (b) the first service feature being dependent upon a functionality of the second feature such as an output of the second service feature that the first service feature utilizes as an input, or (c) an operation executed by the second service feature that directly or indirectly impacts the first service feature.

The term “upstream,” as used herein with reference to an arrangement of a first service feature upstream from a second service features, refers to at least one of the following: (a) the first service feature being arranged prior to the second service feature with respect to a data flow or a sequence of operations, (b) the first service feature having a functionality that the second feature depends upon such as an output of the first service feature that the second service feature utilizes as an input, or (c) an operation executed by the first service feature that directly or indirectly impacts the second service feature.

The term “dependent” or “dependency,” as used herein with reference to a first service feature being dependent upon, or having a dependency from, a second service features, refers to at least one of the following: (a) the first service feature being arranged subsequent to the second service feature with respect to a data flow or a sequence of operations, (b) the first service feature being dependent upon a functionality of the second feature such as an output of the second service feature that the first service feature utilizes as an input, or (c) an operation executed by the second service feature that directly or indirectly impacts the first service feature. In one example, a downstream service feature is dependent upon an upstream service feature.

As used herein, the term “service” refers to a modular, self-contained unit of functionality that is deployed in a cloud infrastructure. A service may encapsulate a specific set of functionalities, utilities, or tasks. A service may include a unit of functionality ranging from a simple standalone application or utility to a complex distributed system that include multiple interconnected components. A service may include a well-defined interface for interaction with other services, service features, or operator device interfaces.

In one example, a service includes a compute instance, a virtual machine, a container, or a storage system. Additionally, or alternatively, a service includes an application, a program, a utility, a resource, a platform, an infrastructure as a service (IaaS), a platform as a service (PaaS), a software as a service (SaaS), a database as a service (DBaaS), a container orchestration service, a serverless computing service, a storage service, a content delivery network (CDN) service, an identity and access management (IAM) service, a networking service, a machine learning or AI service, a big data or analytics service, an internet of things (IoT) service, a blockchain service, a monitoring or logging service, a customized service, or a customer-specific service.

An IaaS may include one or more of the following: virtual machines, compute instances, or cloud servers. A PaaS may include one or more of the following: application hosting, application services, or cloud-native application platforms. A SaaS may include one or more of the following: email and productivity suites, office applications, or collaboration tools. A DBaaS may include one or more of the following: a managed database, a database service, or a database platform. A container orchestration service may include one or more of the following: a container orchestration platform or a cluster management service. A serverless computing service may include one or more of the following: a function as a service (FaaS) or a serverless computing architecture. A storage service may include one or more of the following: object storage, block storage, or file storage. A CDN services may include one or more of the following: a content delivery service, a content caching service, a streaming and media delivery service, or a content automation service. An IAM service may include one or more of the following: an authentication or authorization service, an identity management services, or a federated identity service. A networking services may include one or more of the following: a VPC service or a software-defined networking (SDN) service. A machine learning service may include one or more of the following: a machine learning platform, a model training service, an automated model selection or configuration service, an Al integration service, a model monitoring or management services, or a deep learning service. A big data or analytics service may include one or more of the following: a data warehousing service, an analytics platform, or a data lake service. An IoT service may include one or more of the following: an IoT platform, a device management service, or an edge computing service. A blockchain services may include one or more of the following: a blockchain platform, a distributed ledger service, a smart contracts service, a security or cryptography service, or a tokenization service. A monitoring or logging services may include one or more of the following: a monitoring service, a logging service, or an application performance monitoring service.

As used herein, the term “service feature” refers to a feature, functionality, capability, characteristic, parameter, or facet of a service. A service feature may contribute to an operation, output, state, or quality of a service. A service feature may pertain to build-time and/or run-time of a service. In one example, a service may be a service feature with respect to one or more other services.

In one example, a service feature, such as a service feature that pertains to build-time of a service, includes one or more of the following: a dependency management feature, a build automation feature, a code compilation feature, a code quality feature, a unit testing feature, an artifact generation feature, a configuration management feature, a continuous integration feature, a code packaging feature, a dependency scanning feature, a documentation generation feature, a code obfuscation feature, a versioning feature, a tagging feature, or a build-time optimization feature.

Additionally, or alternatively, a service feature, such as a service feature that pertains to run-time of a service, includes one or more of the following: a deployment feature, an authentication feature, an authorization security feature, an encryption feature, a compliance feature, a content delivery feature, a content caching feature, a logging feature, an auditing feature, a disaster recovery feature, a scalability feature, a virtualization feature, an automation feature, a machine learning integration feature, a reliability feature, an availability feature, a fault tolerance feature, a data redundancy feature, a response time feature, a throughput capacity feature, a data encryption feature, a performance monitoring feature, a performance optimization feature, a resource utilization feature, a load balancing feature, or a patch management feature.

Additionally, or alternatively, a service feature, such as a service feature that pertains to both run-time and build-time of a service, includes one or more of the following: a resource management feature, an error handling and logging feature, a dynamic configuration feature, a thread management feature, a session management feature, a caching feature, a connection pooling feature, or an adaptive security feature.

### C. Example Cloud Infrastructure Protection Utility

Referring to FIG. 11C, a system 1100 that includes a cloud infrastructure protection utility 1120 is further described in accordance with one or more embodiments. FIG. 11C illustrates features of a cloud infrastructure 1102 that includes a virtual cloud network 1106 with a partition 1118 deployed in the virtual cloud network 1106. As shown in FIG. 11C, the partition 1118 includes a cloud infrastructure protection utility 1120, a data corpus 1126, and an operator device interface 1128. Additionally, the partition 1118 includes one or more services 1122 and corresponding service features 1124. As an example, FIG. 11C shows service 1122a and service 1122c. Additionally, FIG. 11C shows service feature 1124a and service feature 1124b of service 1122a, and service feature 1124c and service feature 1124d of service 1122c. Additionally, the cloud infrastructure 1102 described with reference to FIG. 11C may include one or more additional components, features, or functionalities described with reference to FIG. 11A and/or FIG. 11B.

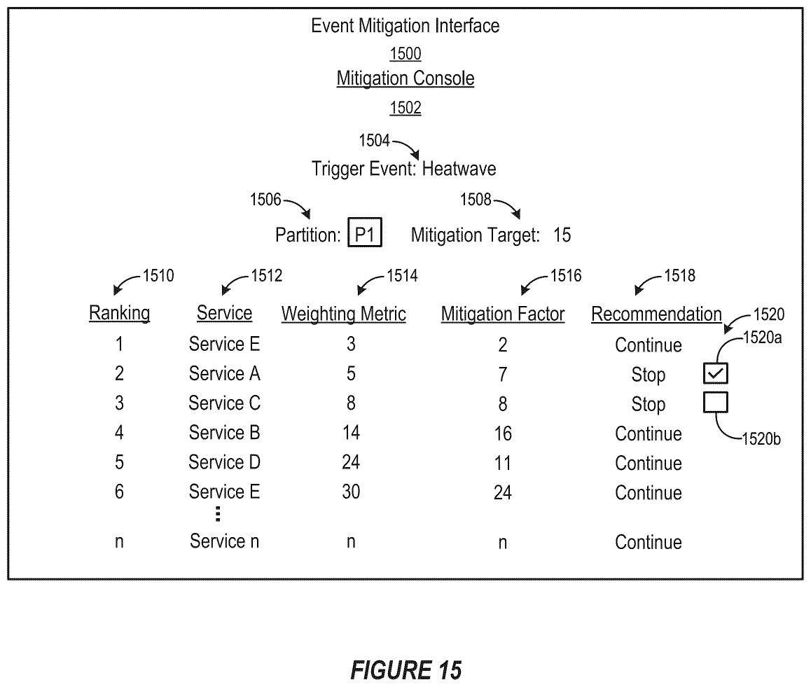

The cloud infrastructure protection utility 1120 may include one or more of the following: a mapping module 1130, a weighting module 1132, a metric computation module 1134, an event detection module 1136, or a service selection module 1138. Additionally, the cloud infrastructure protection utility 1120 includes an event mitigation interface 1140. An example event mitigation interface 1140 is further described with reference to FIG. 15.

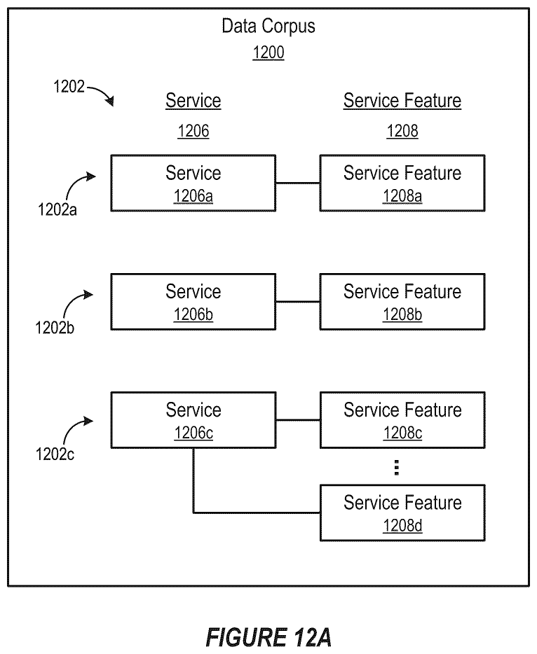

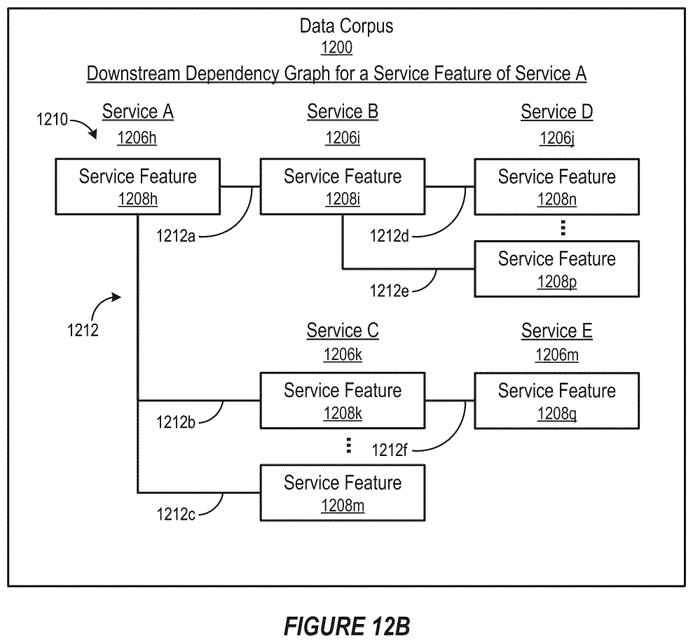

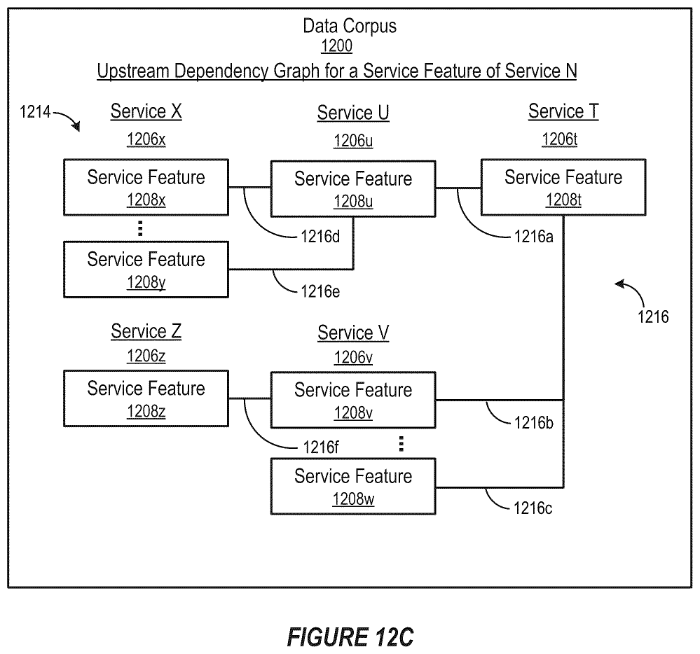

The cloud infrastructure protection utility 1120 detects trigger events that threaten an operability of the cloud infrastructure 1102. Additionally, the cloud infrastructure protection utility 1120 executes mitigation processes for mitigating effects of trigger events. The mitigation processes includes selecting one or more services 1122, from a set of candidate services 1122, for stopping execution to at least partially mitigate effects of trigger events. The cloud infrastructure protection utility 1120 may determine the sets of candidates and/or the services 1122 for stopping based at least in part on one or more datasets stored in the data corpus 1126. The datasets stored in the data corpus 1126 may be generated based on inputs from an operator device interface 1128. Additionally, or alternatively, datasets stored in the data corpus 1126 may be generated based on sensor data or other information from an environmental monitoring system 1110 (FIG. 11A). An example data corpus 1126 is further described with reference to FIGS. 12A-12C.

In one example, a system 1100 that includes one or more components of the cloud infrastructure protection utility 1120 is deployed to the virtual cloud network 1106 concurrently with, or subsequent to, deploying the partition 1118 to the virtual cloud network 1106. In one example, a first entity deploys the partition 1118 and the system 1100 including the one or more components of the cloud infrastructure protection utility 1120 and then transfers operation of the partition 1118 to a second entity. In one example, the first entity is a cloud infrastructure provider, and the second entity is a PLC operator or customer. The second entity utilizes the cloud infrastructure protection utility 1120 in connection with operating the partition 1118. In one example, the second entity accesses the event mitigation interface 1140 of cloud infrastructure protection utility 1120, for example, to input and/or retrieve information pertaining to operations of the cloud infrastructure protection utility 1120. In one example, the first entity and the second entity are distinguishable based on identity resources for the cloud environment. A set of identity resources for the cloud environment may include a first identity domain corresponding to the first entity and a second identity domain corresponding to the second entity. The partition 1118, including the cloud infrastructure protection utility 1120 deployed to the partition 1118, is accessible in accordance with the second identity domain corresponding to the second entity.

i. Example Mapping Module

In one example, the mapping module 1130 generates mappings associated with services 1122 and service features 1124. In one example, the mappings may identify services 1122 and respective service features 1124 of the services 1122. The mappings may define relationships, dependencies, and/or communication channels between service features 1124 and/or services 1122. In one example, the mappings are generated based on inputs from an operator via the operator device interface 1128. Additionally, or alternatively, the mapping module 1130 may include one or more mapping utilities that generate mappings between service features 1124 and services 1122. The one or more mapping utilities may include a service discovery utility, a configuration management utility, an orchestration platform, or an event-driven architecture utility. In one example, the mapping module 1130 utilizes the one or more mapping utilities to dynamically update mappings. The mappings may be dynamically updated as different services 1122 and/or services features 1124 are provisioned and/or deprovisioned in the partition 1118. Example mappings are further described with reference to FIG. 12A.

In one example, the mapping module 1130 generates dependency graphs that indicate dependencies between services 1122 and/or service features 1124. In one example, a dependency graph may include dependencies between different service features 1124. Additionally, or alternatively, a dependency graph may include dependencies between different services 1122. In one example, the dependency graphs are generated based on inputs from an operator via the operator device interface 1128. Additionally, or alternatively, the mapping module 1130 may include one or more dependency graph utilities that generate dependency graphs between service features 1124 and/or services 1122. The one or more dependency graph utilities may include a service discovery utility, a configuration management utility, an orchestration platform, or an event-driven architecture utility. In one example, the mapping module 1130 utilizes the one or more dependency graph utilities to dynamically update dependency graphs. The dependency graphs may be dynamically updated as different services 1122 and/or services features 1124 are provisioned and/or deprovisioned in the partition 1118. Example dependency graphs are further described with reference to FIGS. 12B and 12C.

ii. Example Weighting Module

The weighting module 1132 assigns weights to various weighted items. The weighted items may include services 1122, service features 1124, and/or alarm parameters. Additionally, or alternatively, the weighted items may include mappings, dependencies, and/or nodes. A weight assigned to a weighted item may represent a degree of importance, significance, value, or impact of the weighted item within a given context. A relatively higher weight may indicate that a weighted item is relatively more important, more significant, more valuable, or more impactful. A relatively lower weight may indicate that a weighted item is relatively less important, less significant, less valuable, or less impactful. The weights assigned to weighted items may be stored in the data corpus 1126. In one example, the weights are stored in association with the mappings and/or dependency graphs stored in the data corpus 1126.

In one example, a weight that is assigned to a weighted item (e.g., a service 1122 or a service feature 1124) may represent an importance or value of the weighted item to one or more components or operations of the cloud environment. A weight assigned to a service feature 1124 of a service 1122 may represent an importance or value of the service feature 1124 to the service 1122. A weight assigned to a service 1122 may represent an importance or value of the service 1122 to one or more operational aspects of the cloud environment. Additionally, or alternatively, a weight assigned to a service 1122 may represent an importance or value of the service 1122 to one or more business activities that depend on the service 1122.

In one example, a weight that is assigned to a weighted item (e.g., a service 1122, service feature 1124, or alarm parameter) may represent an impact or significance of the weighted item to one or more components or operations of the cloud environment. A weight assigned to a service feature 1124 of a service 1122 may represent an impact or significance of the service feature 1124 to one or more corresponding services 1122. Additionally, or alternatively, a weight assigned to a service feature 1124 of a service 1122 may represent an impact or significance of the service feature 1124 to one or more downstream service features 1124.

The weighting module 1132 may assign the weights to various nodes, mappings, and/or dependencies. The weight assigned to a particular node may depend on one or more adjacent nodes. In one example, a service 1122 is mapped to a first service feature 1124 that is assigned a first weight and a second service feature 1124 that is assigned a second weight. Additionally, the first weight is greater than the second weight. The first weight, being greater than the second weight, indicates that an importance, significance, value, or impact of the first service feature 1124 with respect to the service 1122 is greater than that of the second service feature 1124 with respect to the service 1122. In one example, an upstream service feature 1124 may have a first weight with respect to a first downstream service feature 1124 and a second weight with respect to a second downstream service feature 1124. The difference in weight between the first downstream service feature 1124 and the second downstream service feature 1124 may indicate that the upstream service feature 1124 is more important, more significant, more valuable, or more impactful to the first downstream service feature 1124 than the second downstream service feature 1124. Additionally, or alternatively, a downstream service feature 1124 may have a first weight with respect to a first upstream service feature 1124 and a second weight with respect to a second upstream service feature 1124. The difference in weight as between the first upstream service feature 1124 and the second upstream service feature 1124 may indicate that an importance, significance, value, or impact of the first upstream service feature 1124 with respect to the downstream service feature 1124 is greater than that of the second upstream service feature on the downstream service feature 1124.

In one example, the weights assigned to weighted items (e.g., a service 1122, a service feature 1124, or an alarm parameter) are generated based on inputs from an operator via the operator device interface 1128. The weighted items may include user-defined weights, such as a user-defined valuation, a user-defined importance, a user-defined significance, and/or a user-defined impact. The user-defined weights may differ as between different partitions. In one example, different tenants, such as PLC operators or customers, may provide different user-defined weights for different services and/or for different instances of a service. A tenant may determine the user-defined weights based on the context of the services, service features, cloud operations, or business activities of the tenant. In one example, the weighted items may include user-defined business values. A user-defined business value of a weighted item may represent the importance, significance, value, or impact of the weighted item on the business or operations of a tenant. The relative importance, significance, value, or impact of various weight items may differ as between different tenants, for example, based on differences in businesses or operations as between different tenants and/or based on differences in priorities as between different tenants.

In one example, the weighting module 1132 may include one or more weighting utilities that generate weights for different weighted items. The one or more weighting utilities may dynamically update weights for weighted items. The weighted items may be dynamically updated based on parameters of the cloud environment. In one example, the weighting module 1132 dynamically updates the weights for one or more weighted items based on one or more of the following types of parameters: events, states, log entries, metrics, thresholds, algorithms, or patterns. In one example, the weighting module 1132 dynamically updates the weights for one or more weighted items based on an operational state, and/or a change in an operational state, of one or more services 1122 and/or service features 1124 corresponding to the weighted item. For example, the weighting module 1132 may dynamically update a weight for a service feature 1124 in response to a service 1122 initiating use of the service feature 1124 and/or in response to the service suspending or terminating use of the service feature 1124. The weighting module 1132 may detect a transition of the service feature from a stopped or paused operational state to an initialization or running operational state, or vice versa. The weighting module 1132 may assign a relatively low weight to the service feature 1124 when in the stopped or paused operational state, for example, based on the service feature 1124 not being utilized by the service 1122. The relatively low weight may indicate that the service feature 1124 has relatively low importance, significance, value, or impact when the service feature is in a stopped or paused operational state. The weighting module 1132 may assign a relatively high weight to the service feature 1124 when in the initialization or running operational state, for example, based on the service feature 1124 being utilized by the service 1122. The relatively high weight may indicate that the service feature 1124 has relatively high importance, significance, value, or impact when the service feature is in an initialization or running operational state. As another example, the weighting module 1132 may assign yet another weight to a service feature in response to determining a transition from an initialization or running operational state to an error or updating operational state. The weighting module 1132 may detect a transition of the service feature from the initialization or running operational state to the error or updating operational state, or vice versa. The difference in weighting may represent a difference in importance, significance, value, or impact of the service as between the initialization or running operational state and the error or updating operational state.

In one example, the weighting module 1132 may utilize a machine learning model to determine weights and/or weighting metrics for various weighted items. Example machine learning models are further described below. Example weighting metrics are further described below with reference to FIGS. 13A and 13B.

iii. Example Metric Computation Module

The metric computation module 1134 computes metrics for the various services 1122 and/or service features 1124. In one example, the metric computation module 1134 computes weighting metrics associated with services 1122 and/or service features 1124, for example, based at least in part on weights assigned to weighted items by the weighting module 1132. Example weighting metrics are further described below with reference to FIGS. 13A and 13B. Additionally, or alternatively, the metric computation module 1134 may compute the health metrics based on alarm data pertaining to alarm parameters obtained from a telemetry service and/or a messaging service. Additionally, or alternatively, the metric computation module 1134 may compute weighting metrics based at least in part on health metrics associated with services 1122 and/or service features 1124.

In one example, the metric computation module 1134 computes a weighting metric for a service 1122 based on weights assigned to one or more service features 1124 of the service 1122. Additionally, or alternatively, the metric computation module 1134 may compute weighting metrics for a service 1122 based on weights assigned to one or more upstream service features 1124 and/or one or more downstream service features 1124 that share a dependency with a particular service feature 1124 of the service 1122. In one example, the metric computation module 1134 computes a weighting metric for a service 1122 based on a health metric determined for the service and/or for one or more service features 1124 of the service 1122. Additionally, or alternatively, the metric computation module 1134 may compute weighting metrics for a service 1122 based on health metrics determined for one or more upstream service features 1124 and/or one or more downstream service features 1124 that share a dependency with a service feature 1124 of the service 1122.

The metric computation module 1134 may store weighting metrics for various services 1122 in the data corpus 1126. Additionally, or alternatively, the metric computation module 1134 may transmit weighting metrics to the service selection module 1138, for example, for selecting services 1122 to stop execution, based on the weighting metrics, to mitigate an effect of a trigger event on the cloud infrastructure 1102.

iv. Example Event Detection Module

The event detection module 1136 detects trigger events that threaten an operability of the cloud infrastructure 1102. In one example, the event detection module 1136 detects trigger events based on sensor data or other information from the environmental monitoring system 1110 (FIG. 11A). Additionally, or alternatively, the event detection module 1136 may detect trigger events based on current, scheduled, or predicted utilization of the cloud infrastructure 1102. Additionally, or alternatively, the event detection module 1136 may utilize a machine learning model to predict trigger events. The machine learning model may predict the trigger events based on sensor data or other information from the environmental monitoring system 1110 (FIG. 11A) and/or based on current, scheduled, or predicted utilization of the cloud infrastructure 1102.

The event detection module 1136 may determine an occurrence of a trigger event by comparing sensor data from the environmental monitoring system 1110 to a threshold. The threshold may correspond to a limit or restriction associated with the operability of at least a portion of the cloud infrastructure 1102. In one example, the event detection module 1136 compares a temperature value, corresponding to a sensor that monitors a temperature associated with the cloud infrastructure 1102, to a temperature threshold that represents a temperature limit for avoiding temperature-related damage to the cloud infrastructure 1102. The event detection module 1136 determines an occurrence of a trigger event when the temperature value meets the temperature threshold. In one example, the event detection module receives an alarm from the environmental monitoring system 1110 (FIG. 11A). The alarm indicates an occurrence of an event or situation that threatens, disrupts, or inhibits an operability of at least a portion of a cloud infrastructure 1102. The event detection module 1136 determines an occurrence of a trigger event in response to receiving the alarm from the environmental monitoring system 1110 (FIG. 11A).

In one example, the event detection module 1136 determines one or more characteristics of the trigger event, for example, based on information from the environmental monitoring system 1110 (FIG. 11A). The characteristics of the trigger event may include one or more of the following: whether the trigger event represents a large-scale or isolated impact on the cloud infrastructure 1102, a portion of the cloud infrastructure 1102 impacted by the trigger event, or the nature or cause of the trigger event. The nature or cause of the trigger event may indicate whether the trigger event is associated with weather, an environmental condition, an equipment failure or malfunction, an operating condition of the cloud infrastructure 1102, malfeasance, or human error.

In one example, when the detection module 1136 detects an occurrence of a trigger event, the event detection module 1136 transmits a message to the service selection module 1138 that includes information pertaining to the trigger event. The information pertaining to the trigger event may include an indication that the event detection module 1136 has detected a trigger event and/or one or more characteristics of the trigger event.

v. Example Service Selection Module

The service selection module 1138 determines sets of candidate services 1122 as candidates for stopping execution of operations in the cloud environment to mitigate effects of trigger events on the cloud infrastructure 1102. Additionally, the selection module 1138 selects services 1122 to be stopped from the sets of candidate services 1122.

The set of candidate services 1122 may include all or a portion of the services 1122 that are executing in the partition 1118. In one example, the service selection module 1138 may determine the candidate services 1122 based on a set of candidacy criteria. The service selection module 1138 may compare various services 1122 to the set of candidacy criteria to determine whether respective services 1122 are eligible to be included in the set of candidate services 1122. The candidacy criteria may include one or more criteria for determining whether a particular service 1122 may be suitable or unsuitable for being stopped and restarted.

In one example, the candidacy criteria may exclude a service 1122 from the set of candidate services 1122 based on one or more of the following: a downstream service that is executing in the cloud environment is dependent upon the service 1122; a downstream service feature is dependent upon the service 1122 or a service feature 1124 of the service 1122; the service 1122 handles essential operations that impact the overall functionality of the cloud environment; stopping the service 1122 may result in data corruption or data loss; the service 1122 has a long startup time; the service 1122 includes stateful operations, session data, or real-time processing; the service 1122 is consuming a significant portion of resources in the cloud environment such that stopping the service could lead to resource contention issues or impact the performance of other services 1122; or the service 1122 is utilizing an insignificant portion of resources in the cloud environment such that stopping the service would provide a minimal contribution towards mitigating an effect of the trigger event on the cloud infrastructure.

In one example, the candidacy criteria may include a service 1122 in the set of candidate services 1122 based on one or more of the following: the service 1122 operates in a stateless manner; the service 1122 does not rely on maintaining session data or state information between requests; the service 1122 is not depended upon by a downstream service; service features 1124 of the service 1122 are not depended upon by downstream service features; the service 1122 is capable of a gracefully stopping operations; the service 1122 has a fast startup time; the service 1122 has a fault-tolerant design; the service 1122 is isolated from essential operations of the cloud environment; or the service 1122 is consuming a meaningful portion of resources in the cloud environment such that stopping the service would provide a meaningful contribution towards mitigating an effect of the trigger event on the cloud infrastructure.

The service selection module 1138 may include and/or exclude services 1122 from the set of candidate services 1122 based on various combinations of candidacy criteria. In one example, the service selection module 1138 may augment the candidacy criteria to provide a suitable set of candidate services 1122. In one example, the service selection module 1138 may utilize a relatively restrictive set of candidacy criteria when a relatively small set of candidate services 1122 is suitable. For example, a relatively small set of candidate services 1122 may be suitable when an effect of a trigger event on the cloud infrastructure 1102 can be mitigated by stopping a relatively few number of services 1122. Additionally, or alternatively, the service selection module 1138 may utilize a relatively inclusive set of candidacy criteria when a relatively large set of candidate services 1122 is suitable. For example, a relatively large set of candidate services 1122 may be suitable when a relatively large number of services 1122 need to be stopped to appreciably mitigate an effect of a trigger event on the cloud infrastructure 1102.

The service selection module 1138 may determine the candidacy criteria based on weighting metrics respectively assigned to the candidacy criteria. The weighting metrics may be utilized to include and/or exclude various candidacy criteria to arrive at a suitable set of candidate services 1122. The weighting metrics may be assigned to the candidacy criteria by the weighting module 1132. The weights assigned to candidacy criteria may include user-defined weights, such as a user-defined valuation, a user-defined importance, a user-defined significance, and/or a user-defined impact. The user-defined weights may differ as between different partitions. In one example, different tenants, such as PLC operators or customers, may provide different user-defined weights for different candidacy criteria. A tenant may determine the user-defined weights based on the context of the services, service features, cloud operations, or business activities of the tenant. Additionally, or alternatively, the weighting module 1132 may utilize one or more weighting utilities to generate weights for the various candidacy criteria.

In one example, the service selection module 1138 may determine a mitigation target that represents a target level of mitigation for an effect of a trigger event on the cloud infrastructure 1102. Additionally, or alternatively, the service selection module 1138 may determine to what extent stopping the respective candidate services 1122 may mitigate the effect of the trigger event on the cloud infrastructure 1102. The service selection module 1138 may compute mitigation factors for the candidate services 1122 that respectively represent to what extent stopping a particular candidate services 1122 may mitigate the effect of the trigger event on the cloud infrastructure 1102. The service selection module 1138 may determine the set of candidate services 1122 based on the mitigation target and/or the mitigation factors for various services 1122. In one example, the service selection module 1138 includes a number of services 1122 in the set of candidate services 1122 such that the combined mitigation factor of the number of services 1122 meets or exceeds the mitigation target. Additionally, or alternatively, the service selection module 1138 may include a number of services 1122 in the set of candidate services 1122 such that the combined mitigation factor of the number of services 1122 exceeds the mitigation target by a threshold. The threshold may provide a suitable number of services 1122 in the set of candidate services 1122.

The service selection module 1138 may select a service 1122, from the set of candidate services 1122, for stopping execution based at least in part on weighting metrics corresponding, respectively, to the services 1122. The service selection module 1138 may obtain the weighting metrics from the metric computation module 1134 and/or from the data corpus 1126. In one example, the service selection module 1138 may select a service 1122 for stopping that has a lower weighting metric relative to one or more other candidate services 1122. The lower weighting metric of the service 1122 may indicate that stopping the service 1122 may have less of an impact, for example, on operations performed in the partition 1118 of the cloud environment and/or on business activities that depend on operations performed in the partition 1118 of the cloud environment. Additionally, or alternatively, the service selection module 1138 may select a service 1122 for stopping based on mitigation factors corresponding, respectively, to the services 1122. In one example, the service selection module 1138 may select a service 1122 for stopping that has a higher mitigation factor relative to one or more other candidate services 1122. Additionally, or alternatively, the service selection module 1138 may select a service 1122 for stopping based on a combination of the weighting metrics and the mitigation factors. The service selection module 1138 may select one or more services 1122 for stopping that sufficiently mitigates the effect of the trigger event on the cloud infrastructure 1102, while having a relatively low impact on operations performed in the partition 1118 of the cloud environment and/or on of business activities that depend on operations performed in the partition 1118 of the cloud environment.

In one example, upon having selected one or more services 1122 for stopping, the service selection module 1138 may initiate a stopping process for stopping execution of operations of the one or more services 1122. The stopping process may include stopping operations that depend on the particular service being stopped. The stopping operations for stopping a service 1122 may include one or more of the following: backing up and/or exporting data associated with the service 1122, notifying stakeholders that the service 1122 is being stopped, obtaining approval from stakeholders to stop the service 1122, scheduling a time for stopping the service 1122, or stopping execution of the service 1122.

vi. Event Mitigation Interface

The event mitigation interface 1140 generates and displays visual representations of various information pertaining to trigger events that are detected and to services that may be stopped to mitigate effects of the trigger events on the cloud infrastructure 1102. The information generated and displayed by the event mitigation interface 1140 may include an indication that a trigger event has been detected. Additionally, the information generated and displayed by the event mitigation interface 1140 may identify one or more services 1122 as candidates for stopping execution of operations in the cloud environment. Additionally, the information generated and displayed by the event mitigation interface 1140 may include weighting metrics, mitigation factors, rankings, and operational statuses, respectively, for the one or more services 1122. An example event mitigation interface 1140 is further described below with reference to FIG. 15.

### C. Example Operator Device Interface

In one example, the operator device interface 1128 is couplable or communicatively coupled with the cloud infrastructure protection utility 1120. The operator device interface 1128 may include hardware and/or software configured to facilitate interactions between an operator and the cloud infrastructure protection utility 1120 and/or other aspects of the system 1100. The operator device interface 1128 may render user interface elements and receive input via user interface elements. For example, the operator device interface 1128 may display outputs generated by the cloud infrastructure protection utility 1120. Additionally, or alternatively, the operator device interface 1128 may be configured to receive inputs to the cloud infrastructure protection utility 1120. Examples of interfaces include a GUI, a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by the operator device interface 1128.

In an embodiment, different components of an operator device interface 1128 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the operator device interface 1128 may be specified in one or more other languages, such as Java, C, or C++.

In one example, the cloud infrastructure protection utility 1120 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

### D. Example Machine Learning Models

Referring further to FIG. 11C, in one example, the cloud infrastructure protection utility 1120 may include and/or utilize at least one machine learning model 1142. As shown in FIG. 11C, machine learning model 1142 is shown as being located within partition 1118. Additionally, or alternatively, a machine learning model 1142 utilized by the cloud infrastructure protection utility may be located elsewhere in the virtual cloud network 1106. The cloud infrastructure protection utility 1120 may utilize a machine learning model 1142 to generate mappings, for example, between service features 1124 and services 1122. Additionally, or alternatively, the cloud infrastructure protection utility 1120 may utilize a machine learning model 1142 to generate dependency graphs for service features 1124 and/or services 1122. Additionally, or alternatively, the cloud infrastructure protection utility 1120 may utilize a machine learning model 1142 to determine weights for weighted items (e.g., services 1122, service features 1124, and/or candidacy criteria). Additionally, or alternatively, the cloud infrastructure protection utility 1120 may utilize a machine learning model 1142 to determine mitigation factors for services 1122 that represent an extent that stopping a particular services 1122 may mitigate an effect of a trigger event on the cloud infrastructure 1102.

A machine learning algorithm 1144 may include one or more machine learning algorithms 1144, such as supervised algorithms and/or unsupervised algorithms. Various types of algorithms may be used, such as linear regression, logistic regression, linear discriminant analysis, classification and regression trees, naïve Bayes, k-nearest neighbors, learning vector quantization, support vector machine, bagging, and random forest, boosting, backpropagation, and/or clustering. Additionally, or alternatively, to a machine learning model 1142, the cloud infrastructure protection utility 1120 may utilize one or more classical models. A classical model may include one or more classical statistical algorithms that rely on a set of assumptions about one or more of the underlying data, the data generating process, or the relationships between the variables. Example classical statistical algorithms may include linear regression, logistic regression, ANOVA (analysis of variance), or hypothesis testing.

In one example, a machine learning algorithm 1144 can be iterated to learn a target model f that best maps a set of input variables to an output variable. In particular, a machine learning algorithm 1144 may be configured to generate and/or train a machine learning model 1142. A machine learning algorithm 1144 may be iterated to learn a target model f that best maps a set of input variables to an output variable using a set of training data. Training data used by a machine learning algorithm 1144 may be stored in the data corpus 1126. The training data may include datasets and associated labels. The datasets may be associated with input variables for the target model f. The associated labels may be associated with the output variable of the target model f. The training data may be updated based on, for example, feedback on the accuracy of the current target model f. Updated training data may be fed back into the machine learning algorithm 1144 that, in turn, updates the target model f.

A machine learning algorithm 1144 may generate a target model f such that the target model f best fits the datasets of training data to the labels of the training data. Additionally, or alternatively, a machine learning algorithm 1144 may generate a target model/such that when the target model f is applied to the datasets of the training data, a maximum number of results determined by the target model/matches the labels of the training data. Different target models may be generated based on different machine learning algorithms 1144 and/or different sets of training data.

In one example, as shown in FIG. 11C, the cloud infrastructure protection utility 1120 may include a model trainer 1146 that utilizes one or more machine learning algorithms 1144 to generate and/or train a machine learning model 1142. In one example, the model trainer 1146 may obtain and/or generate feedback from one or more of the machine learning models 1142. The model trainer 1146 may train, update, and/or retrain one or more of the machine learning models 1142 based at least in part on the feedback. The feedback may correspond to one or more outputs of at least one machine learning model 1142. In one example, the model trainer 1146 may obtain one or more training datasets. The model trainer 1146 may train a machine learning model 1142 utilized by the cloud infrastructure protection utility 1120 based at least in part on the one or more training datasets.

The training datasets may be stored in the data corpus 1126. In one example, the training data may include outputs from one or more of the machine learning models 1142. For example, a machine learning model 1142 may be iteratively trained and/or retrained based at least in part on outputs generated by one or more of the machine learning models 1142. A machine learning model 1142 may be iteratively improved over time as additional datasets are analyzed by the machine learning model 1142 to produce additional outputs, and the machine learning model 1142 is iteratively trained or retrained based on the additional outputs.

In one example, the training data may include one or more initial supervised learning datasets. The model trainer 1146 may train a machine learning model 1142 based at least in part on the one or more initial supervised learning datasets. In one example, the training data may include one or more subsequent supervised learning datasets. The model trainer 1146 may update or retrain the machine learning model 1142 based on one or more subsequent supervised learning datasets. The one or more subsequent supervised learning datasets may be generated based at least in part on feedback corresponding to one or more outputs of the machine learning model 1142.

### E. Example Data Corpus

FIGS. 12A-12C illustrate features of an example data corpus 1200. The data corpus 1200 described with reference to FIGS. 12A-12C may be included in one or more embodiments described with reference to FIGS. 11A-11C. Additionally, or alternatively, one or more features of the data corpus 1126 described with reference to FIGS. 11A-11C may be included in the data corpus 1200 described with reference to FIGS. 12A-12C.

i. Example Mappings of Services Features to Service

As shown in FIG. 12A, a data corpus 1200 includes mappings 1202. The mappings 1202 include mapped relationships between services 1206 and service features 1208. The mapped relationships between services 1206 and service features 1208 identify particular service features 1208 of a particular service 1206.

In one example, the data corpus 1200 includes mappings 1202 of a particular service feature 1208 to a particular service 1206. As one example, mapping 1202a maps service feature 1208a to service 1206a. As another example, mapping 1202b maps service feature 1208b to service 1206b. Additionally, or alternatively, the data corpus 1200 may include mappings 1202 that map a particular service 1206 to service features 1208 the particular service 1206. As one example, mapping 1202c maps service 1206c to service feature 1208c and service feature 1208d.

The mappings 1202 stored in the data corpus 1200 represent all or a subset of services 1206 deployed in a partition. Additionally, or alternatively, the mappings 1202 stored in the data corpus 1200 represent all or a subset of service features 1208 for a particular service 1206.

In one example, the data corpus 1200 includes a particular set of mappings 1202 that are determined to be of particular interest for selecting services 1206 as candidates for stopping execution of operations in the cloud environment to mitigate effects of trigger events on the cloud infrastructure. The data corpus 1200 may include mappings 1202 that are defined by a user such as a cloud operator. The mappings 1202 that are defined by a user may correspond to particular services 1206 and/or service features 1208 that are of interest to the user. Additionally, or alternatively, the data corpus 1200 may include mappings 1202 that are automatically generated by a mapping utility. The mappings 1202 that are automatically generated by a mapping utility may correspond to particular services 1206 and/or service features 1208 that the mapping utility determines may be of interest to a user such as a cloud operator.

ii. Example Dependency Graphs

Referring to FIGS. 12B and 12C, the data corpus 1200 may include dependency graphs that map functional dependencies between service features. A dependency graph represents dependencies associated with one or more service features 1208. In one example, the dependency graphs may include downstream dependency graphs 1210 that represent downstream dependencies 1212 for one or more service features 1208. The downstream dependencies 1212 for a particular service feature 1208 indicate downstream service features 1208 that are dependent upon, or impacted by, or one or more functionalities or operations of the particular service feature 1208. Additionally, or alternatively, in one example, the dependency graphs may include upstream dependency graphs 1214 that represent upstream dependencies 1216 for one or more service features 1208.

FIG. 12B illustrates an example downstream dependency graph 1210 for service feature 1208h of service 1206h. The downstream dependency graph 1210 illustrated in FIG. 12B represents downstream dependencies 1212 for service feature 1208h. The downstream dependencies 1212 identify service features 1208 that are dependent upon, or impacted by, service feature 1208h of service 1206h. As one example, the downstream dependency graph 1210 includes downstream dependency 1212a between service feature 1208h and service feature 1208i of service 1206i. Downstream dependency 1212a indicates that service feature 1208i is dependent upon, or impacted by, service feature 1208h. As another example, downstream dependency 1212b and downstream dependency 1212c indicate, respectively, that both service feature 1208k and service feature 1208m of service 1206k are dependent upon, or impacted by, service feature 1208h.

The downstream dependencies 1212 may include one or more downstream service features 1208 that are dependent upon, or impacted by, a particular service feature 1208 that is dependent upon, or impacted by, another service feature 1208. As one example, the downstream dependency graph 1210 includes downstream dependency 1212d between service feature 1208i of service 1206i and service feature 1208n of service 1206j as well as downstream dependency 1212e between service feature 1208i and service feature 1208p. Together, downstream dependency 1212a and downstream dependency 1212d indicate that service feature 1208n is dependent upon, or impacted by, service feature 1208h. Additionally, downstream dependency 1212a and downstream dependency 1212e indicate that service feature 1208p is dependent upon, or impacted by, service feature 1208h. Service feature 1208n and/or service feature 1208p may, respectively, be indirectly dependent upon service feature 1208h by virtue of the dependency from service feature 1208i indicated, respectively, by downstream dependency 1212d and downstream dependency 1212e. As another example, downstream dependency 1212f between service feature 1208k of service 1206k and service feature 1208q of service 1206m indicate that service feature 1208p is dependent upon, or impacted by, service feature 1208h. Service feature 1208q may be indirectly dependent upon service feature 1208h by virtue of the dependency from service feature 1208k indicated by downstream dependency 1212f.

FIG. 12C illustrates an example upstream dependency graph 1214 for service feature 1208t of service 1206t. The upstream dependency graph 1214 illustrated in FIG. 12C represents upstream dependencies 1216 for service feature 1208t. The upstream dependencies 1216 identify upstream service features 1208 from service feature 1208t of service 1206t. Service feature 1208t depends upon, or is impacted by, the upstream service features 1208. As one example, the upstream dependency graph 1214 includes upstream dependency 1216a between service feature 1208t and service feature 1208u of service 1206u. Upstream dependency 1216a indicates that service feature 1208t depends upon, or is impacted by, service feature 1208u. As another example, upstream dependency 1216b and upstream dependency 1216c indicate, respectively, that service feature 1208t depends upon, or is impacted by, service feature 1208v and service feature 1208w of service 1206v.

The upstream dependencies 1216 may include one or more upstream service features 1208 that are dependent upon, or impacted by, another upstream service feature 1208. As one example, the upstream dependency graph 1214 includes upstream dependency 1216d between service feature 1208u of service 1206u and service feature 1208x of service 1206x as well as upstream dependency 1216e between service feature 1208u and service feature 1208y. Together, upstream dependency 1216a and upstream dependency 1216d indicate that service feature 1208t is dependent upon, or impacted by, service feature 1208x. Additionally, upstream dependency 1216a and upstream dependency 1216e indicate that service feature 1208t is dependent upon, or impacted by, service feature 1208y. Service feature 1208t may be indirectly dependent upon, or indirectly impacted by, service feature 1208x and/or service feature 1208y by virtue of the upstream dependencies respectively indicated by upstream dependency 1216d and upstream dependency 1216e. As another example, upstream dependency 1216f between service feature 1208v of service 1206v and service feature 12082 of service 1206z indicate that service feature 1208t is dependent upon, or impacted by, service feature 1208z. Service feature 1208t may be indirectly dependent upon service feature 12082 by virtue of upstream dependency 1216f.

The data corpus 1200 may include dependency graphs for all or a subset of service features 1208 of a particular services 1206 deployed in a partition. Additionally, or alternatively, the dependency graphs stored in the data corpus 1200 represent all or a subset of downstream dependencies 1212 and/or upstream dependencies 1216 between various service features 1208. In one example, the data corpus 1200 includes a particular set of dependency graphs for service features 1208 that are determined to be of particular interest for selecting services 1206 as candidates for stopping execution of operations in the cloud environment to mitigate effects of trigger events on the cloud infrastructure. For example, a service 1206 may be selected based on weighting metrics that represent an impact that services features 1208 of the service 1206 have on downstream service features 1208. Additionally, or alternatively, a service 1206 may be selected based on weighting metrics that represent an impact that upstream service features 1208 have on services features 1208 of the service 1206. The data corpus 1200 may include dependency graphs that are defined by a user such as a cloud operator. The dependency graphs that are defined by a user may correspond to particular service features 1208 and/or services 1206 that are of interest to the user. Additionally, or alternatively, the data corpus 1200 may include dependency graphs that are automatically generated by a mapping utility. The dependency graphs that are automatically generated by a mapping utility may correspond to particular service features 1208 and/or services 1206 that the mapping utility determines may be of interest to a user such as a cloud operator.

In one or more embodiments, the data corpus 1200 is any type of storage unit and/or device (e.g., a file system, database, collection of tables, or any other storage mechanism) for storing data. Further, the data corpus 1200 may include multiple different storage units and/or devices. The multiple different storage units and/or devices may or may not be of the same type or located at the same physical site. Further, the data corpus 1200 may be implemented or executed on the same computing system as the cloud infrastructure protection utility 1120 (FIGS. 11A-11C). Additionally, or alternatively, the data corpus 1200 may be implemented or executed on a computing system separate from the cloud infrastructure protection utility 1120 (FIGS. 11A-11C). The data corpus 1200 may be communicatively coupled to the cloud infrastructure protection utility 1120 (FIGS. 11A-11C) via a direct connection or via a network. Information describing the data corpus 1200 may be implemented across any of components of the system 1100 (FIGS. 11A-11C). However, this information is described with reference to the data corpus 1200 for purposes of clarity and explanation.

### 4. Example Weighting Metrics

Referring to FIGS. 13A and 13B, example weighting metrics are further described. In one example, the weighting metrics represent an impact that a particular service feature has on one or more downstream service features and/or an impact that one or more upstream service features has on a particular service feature. A weighting metric may represent a sum, product, or composite of one or more input parameters utilized to compute the weighting metric. Additionally, or alternatively, the one or more input parameters may include functions, operators, variables, or constants. The one or more input parameters may be associated with a service and/or a service feature. The one or more input parameters may include weights applied to services and/or service features. The examples described below with reference to FIGS. 13A and 13B are provided for purposes of clarity and should not be construed as limiting the scope of any of the claims.

### A. Metrics Based on Impacts on Downstream Service Features

Referring to FIG. 13A, metrics 1300 that represent impacts of service features on downstream service features are further described. The metrics 1300 include weighting metrics computed for services based on weights assigned to service features and/or services. The weighting metric for a service may represent a degree of importance, significance, value, or impact that one or more service features of the service have on one or more downstream services.

As shown in FIG. 13A, the system computes a weighting metric 1302a for service 1304a based on an impact that one or more service features 1306 of service 1304a have on one or more downstream service features 1306 of one or more downstream services 1304. Service 1304a includes service feature 1306a and service feature 1306b. In one example, a service feature may impact one or more downstream service features of one or more downstream services. Service feature 1306a impacts downstream service feature 1306c of service 1304c. Additionally, service feature 1306a impacts downstream service feature 1306d of service 1304d. In one example, a service feature may impact multiple downstream service features of a particular downstream services. Service feature 1306b impacts downstream service feature 1306e and downstream service feature 1306f of service 1304e.

In one example, the system computes weighting metric 1302a for service 1304a based on a count of the downstream service features 1306 that are impacted by a service feature 1306 of service 1304a. Additionally, or alternatively, the system may compute weighting metric 1302a based on a dependency weight for a service feature 1306. The system may determine a dependency weight for a service feature based on one or more downstream service features that depend on the service feature. In one example, the weighting metric 1302a is based on dependency weight 1308a corresponding to service feature 1306a and/or dependency weight 1308b corresponding to service feature 1306b.

In one example, the system determines the dependency weight based on a count of the downstream service features. The system determines a count of the downstream service features and computes the dependency weight based on the count of the downstream service features. In one example, the dependency weight is the count of downstream service features. In one example, the dependency weight represents a product of the count of the downstream service and one or more functions, operators, variables, or constants. Additionally, or alternatively, the system determines the dependency weight based on features weights for one or more downstream service features that depend on the service feature. Additionally, or alternatively, the dependency weight for a service feature may be computed based on a feature weight of the service feature. The feature weight of a service feature 1306 may represent an importance, significance, value, or impact of the service feature 1306.

As shown in FIG. 13A, the system computes dependency weight 1308a of service feature 1306a based on feature weight 1310c and feature weight 1310d. Feature weight 1310c corresponds to downstream service feature 1306c of service 1304c. Feature weight 1310d corresponds to downstream service feature 1306d of service 1304d. In one example, the dependency weight 1308a of service feature 1306a is additionally based on feature weight 1310a of service feature 1306a. In one example, dependency weight 1308a represents a sum, product, or composite of feature weight 1310a, feature weight 1310c, and feature weight 1310d. Additionally, or alternatively, dependency weight 1308a may represent a product of one or more functions, operators, variables, or constants associated with service feature 1306a, downstream service feature 1306c, and/or downstream service feature 1306d. As shown in FIG. 13A, dependency weight 1308a has a value of (8) representing a product of feature weight 1310c, feature weight 1310d, and feature weight 1310a (e.g., 2×4×1=8).

Additionally, or alternatively, as shown in FIG. 13A, the system computes dependency weight 1308b of service feature 1306b based on feature weight 1310e and feature weight 1310f. Feature weight 1310e corresponds to downstream service feature 1306c of service 1304c. Feature weight 1310f corresponds to downstream service feature 1306d of service 1304c. In one example, the dependency weight 1308b of service feature 1306b is additionally based on feature weight 1310b of service feature 1306b. In one example, dependency weight 1308b represents a sum, product, or composite of feature weight 1310b, feature weight 1310e, and feature weight 1310f. Additionally, or alternatively, dependency weight 1308b may represent a product of one or more functions, operators, variables, or constants associated with service feature 1306b, downstream service feature 1306e, and/or downstream service feature 1306f. As shown in FIG. 13A, dependency weight 1308b has a value of (3) representing a product of feature weight 1310e, feature weight 1310f, and feature weight 1310b (e.g., 1×3×1=3).

In one example, as shown in FIG. 13A, the system computes weighting metric 1302a based on dependency weight 1308a of service feature 1306a and dependency weight 1308b of service feature 1306b. In one example, the system may compute weighting metric 1302a based additionally on service weight 1312a of service 1304a. Service weight 1312a may represent an importance, significance, value, or impact of the service 1304a, for example, separate or in addition to, the importance, significance, value, or impact of the service feature 1306 of service 1304a. In one example, weighting metric 1302a represents a sum, product, or composite of dependency weight 1308a, dependency weight 1308b, and service weight 1312a. As shown in FIG. 13A, weighting metric 1302a has a value of (55) representing a product of service weight 1312a and dependency weight 1308a combined with a product of service weight 1312a and dependency weight 1308b (e.g., 8×5+3×5=55).

B. Metrics Based on Impacts from Upstream Service Features

Referring to FIG. 13B, metrics 1300 based on impacts on service features from upstream service features are further described. The metrics 1300 include weighting metrics computed for services based on weights assigned to service features and/or service features. The weighting metric for a service may represent a degree of importance, significance, value, or impact that one or more upstream services have on the service features of the service.

As shown in FIG. 13B, the system computes a weighting metric 1302t for service 1304t based on an impact that one or more upstream service features 1306 have on one or more service features 1306 of service 1304t. Service 1304t includes service feature 1306t and service feature 1306v. In one example, a service feature may be impacted by one or more upstream service features of one or more upstream services. Service feature 1306t is impacted by upstream service feature 1306w of service 1304w. Additionally, service feature 1306t is impacted by upstream service feature 1306x of service 1304x. In one example, a service feature may be impacted by multiple upstream service features of a particular upstream services. Service feature 1306v is impacted by upstream service feature 1306y and upstream service feature 1306z of service 1304z.

In one example, the system computes weighting metric 1302t for service 1304t based on a count of the downstream service features 1306 that are impacted by a service feature 1306 of service 1304t. Additionally, or alternatively, the system may compute weighting metric 1302t based on a dependency weight for a service feature 1306. The system may compute a dependency weight for a service feature based on one or more upstream service features that are depended upon by the service feature. In one example, the weighting metric 1302t is based on dependency weight 1308t corresponding to service feature 1306t and/or dependency weight 1308v corresponding to service feature 1306v.

In one example, the system determines the dependency weight based on a count of the upstream service features. The system determines a count of the upstream service features and computes the dependency weight based on the count of the upstream service features. In one example, the dependency weight is the count of upstream service features. In one example, the dependency weight represents a product of the count of the upstream service and one or more functions, operators, variables, or constants. Additionally, or alternatively, the system determines the dependency weight based on features weights for one or more upstream service features that are depended upon by the service feature. Additionally, the dependency weight for a service feature may be computed based on a feature weight of the service feature. The feature weight of a service feature 1306 may represent an importance, significance, value, or impact of the service feature 1306.

In one example, as shown in FIG. 13B, the system computes dependency weight 1308t of service feature 1306t based on feature weight 1310w and feature weight 1310x. Feature weight 1310w corresponds to upstream service feature 1306w of service 1304w. Feature weight 1310x corresponds to upstream service feature 1306x of service 1304x. In one example, the dependency weight 1308t of service feature 1306t is additionally based on feature weight 1310t of service feature 1306t. In one example, dependency weight 1308t represents a sum, product, or composite of feature weight 1310t, feature weight 1310w, and feature weight 1310x. Additionally, or alternatively, dependency weight 1308t may represent a product of one or more functions, operators, variables, or constants associated with service feature 1306t, upstream service feature 1306w, and/or upstream service feature 1306x. As shown in FIG. 13A, dependency weight 1308t has a value of (9) representing a product of feature weight 1310w, feature weight 1310x, and feature weight 1310t (e.g., 3×3×1=9).

Additionally, or alternatively, as shown in FIG. 13B, the system computes dependency weight 1308v of service feature 1306v based on feature weight 1310y and feature weight 1310z. Feature weight 1310y corresponds to upstream service feature 1306y of service 1304z. Feature weight 1310z corresponds to upstream service feature 1306z of service 1304z. In one example, the dependency weight 1308v of service feature 1306v is additionally based on feature weight 1310v of service feature 1306v. In one example, dependency weight 1308v represents a sum, product, or composite of feature weight 1310v, feature weight 1310y, and feature weight 1310z. Additionally, or alternatively, dependency weight 1308v may represent a product of one or more functions, operators, variables, or constants associated with service feature 1306v, upstream service feature 1306y, and/or upstream service feature 13062. As shown in FIG. 13A, dependency weight 1308v has a value of (2) representing a product of feature weight 1310y, feature weight 1310z, and feature weight 1310v (e.g., 2×1×1=2).

In one example, as shown in FIG. 13B, the system computes weighting metric 1302t based on dependency weight 1308t of service feature 1306t and dependency weight 1308v of service feature 1306v. In one example, the system may compute weighting metric 1302t based additionally on service weight 1312t of service 1304t. Service weight 1312t may represent an importance, significance, value, or impact of the service 1304t, for example, separate or in addition to, the importance, significance, value, or impact of the service feature 1306 of service 1304t. In one example, weighting metric 1302t represents a sum, product, or composite of dependency weight 1308t, dependency weight 1308v, and service weight 1312t. As shown in FIG. 13A, weighting metric 1302t has a value of (33) representing a product of service weight 1312t and dependency weight 1308t combined with a product of service weight 1312t and dependency weight 1308v (e.g., 3×9+3×2=33).

### 5. Example Operations for Cloud Infrastructure Protection

Referring to FIGS. 14A and 14B, example operations 1400 are further described in accordance with one or more embodiments. In one example, a system may execute operations 1400 pertaining to cloud infrastructure protection, including operations 1400 pertaining to responding to trigger events that threaten an operability of a cloud infrastructure. One or more operations 1400 described with reference to FIGS. 14A and 14B may be modified, combined, rearranged, or omitted. Accordingly, the particular sequence of operations 1400 described with reference to FIGS. 14A and 14B should not be construed as limiting the scope of one or more embodiments. In one example, the operations 1400 may be performed by the one or more components of the system described with reference to FIGS. 11A-11C.

Referring to FIG. 14A, a system detects an occurrence of a trigger event that threatens an operability of at least a portion of a cloud infrastructure (Operation 1402). The system may detect the trigger event based on sensor data or other information from an environmental monitoring system. In one example, the trigger event includes one or more of the following: severe weather, a heatwave, a storm, a natural disaster, a cold snap, a hurricane, a blizzard, a tornado, a sandstorm, a flood, a fire, a detonation, wind, rain, snow, ice, haze, or smog. Additionally, or alternatively, the trigger event may include one or more of the following: a hardware failure, a power outage, a utilities outage, a transition to a backup power source, a power supply limitation, a brownout, a blackout, a cloud infrastructure outage, a cooling system failure, a ventilation system failure, a heating system failure, a network disruption, a software bug, a cybersecurity incident, a security breach, a system upgrade, or a maintenance event.

In response to detecting the trigger event, the system executes a mitigation process for mitigating an effect of the trigger event (Operation 1404). The mitigation process includes stopping execution of operations of one or more services in a cloud environment. Example operations 1400 of the mitigation process are further described below with reference to FIG. 14B. In one example, during and/or after execution of the mitigation process, the system determines whether the effect of the trigger event is sufficiently mitigated (Operation 1406). When the system determines that the effect of the trigger event is not sufficiently mitigated, the system continues executing the mitigation process at operation 1404. When the system determines that the effect of the trigger event is sufficiently mitigated, the system resumes execution of operations of the one or more services (Operation 1408).

Referring to FIG. 14B, example operations 1400 of a mitigation process are further described. As shown in FIG. 14B, a system determines a set of candidate services as candidates for stopping execution of operations (Operation 1410). The set of candidate services may be determined based on candidacy criteria for determining whether a particular service is suitable or unsuitable for being stopped and restarted. The system generates a ranking of the set of candidate services based at least on weighting metrics associated with the respective service features (Operation 1412). Based at least on the ranking, the system selects a service from the set of candidate services for stopping execution of operations (Operation 1414). The system may identify the service features of the set of candidate services based on mappings of the candidate services to service features of the respective candidate services. The mapping may be stored in a data repository and/or in metadata associated with the respective services. The system may generate the rankings based on weights assigned to the respective service features.

Upon having selected a service for stopping execution of operations, the system stops execution of operations of the selected service to at least partially mitigate the trigger event (Operation 1416). The system may stop execution of operations of the selected service by executing a stopping process corresponding to the selected service. The stopping process may include one or more of the following stopping operations: backing up and/or exporting data associated with the service 1122, notifying stakeholders that the service 1122 is being stopped, obtaining approval from stakeholders to stop the service 1122, scheduling a time for stopping the service 1122, or stopping execution of the service 1122.

During or after stopping execution of operations of the selected service, the system determines whether the effect of the trigger event is sufficiently mitigated (Operation 1418). When the system determines that the effect of the trigger event is not sufficiently mitigated, the system selects another service from the set of candidate services for stopping execution of operations (Operation 1414). When the system determines that the effect of the trigger event is sufficiently mitigated, the system resumes execution of operations of the one or more services that were stopped (Operation 1408). The system may resume execution of operations of the one or more services that were stopped by starting the services gradually, such as in a sequence representing an inverse of the sequence that the services were stopped. Additionally, or alternatively, the services that were stopped may be started together as a group. Starting a service may include one or more of the following: transmitting an instruction to the service to resume executing operations of the service, notifying stakeholders that the service is started, or scaling up utilization of the service.

In one example, the trigger event includes a high temperature associated with at least a portion of the cloud infrastructure, and stopping one or more services at least partially mitigates the high temperature. In one example, the trigger event includes an outage associated with at least a portion of the cloud infrastructure, and stopping at least partially mitigates a resource constraint associated with a resource parameter of the cloud environment.

In one example, the ranking utilized to select the service for stopping is further based on feature weights associated with one or more downstream service features that depend upon one or more service features of the respective candidate services. The system may determine the feature weights based on a dependency graph that graphs dependencies between services and service features. In one example, the ranking is further based on feature metrics that represent operational impacts associated with respective service features of the set of candidate services. In one example, the data corpus includes a foreign key representing the service feature that corresponds to a primary key representing the dependency graph for the service feature. The system may determine the foreign key from the mapping between the service feature and the service. The system may determine the one or more downstream service features by traversing the dependency graph and retrieving values corresponding to the downstream service features.

In one example, the system determines a ranking adjustment corresponding to one or more services of the set of candidate services based on one or more previous occurrences of a particular service having been stopped in connection with one or more previous trigger events. The system may adjust the ranking to avoid having the particular service being repeatedly stopped. As a result of adjusting the ranking, one or more services are ranked higher in the ranking than if the ranking had not been adjusted, and/or one or more services are ranked lower in the ranking than if the ranking had not been adjusted.

### 6. Example Event Mitigation Interface

FIG. 15 illustrates an example event mitigation interfaces in accordance with one or more embodiments. The example event mitigation interface may be utilized for cloud infrastructure protection, including responding to trigger events that threaten an operability of a cloud infrastructure. The event mitigation interface may be utilized to monitor operations of the system and/or to initiate and/or approve operations of the system, such as stopping services executing in the cloud environment to at least partially mitigate effects of trigger events on the cloud infrastructure. The examples provided with reference to FIG. 15 are for purposes of clarity. Components and/or operations described with reference to FIG. 15 should be understood as an example that may not be applicable to certain embodiments. Accordingly, components and/or operations described with reference to FIG. 15 should not be construed as limiting the scope of any of the claims.

As shown in FIG. 15, in one example, an event mitigation interface 1500 indicates a mitigation console 1502 that displays information pertaining to trigger events. As shown in FIG. 15, the mitigation console 1502 indicates an occurrence of a trigger event 1504. As an example, the trigger event 1504 is a heatwave. Additionally, the mitigation console 1502 indicates a mitigation target 1508 for mitigating the trigger event 1504. The mitigation target 1508 may correspond to a particular partition 1506 of the cloud environment. In one example, as shown in FIG. 15, the mitigation target 1508 for Partition PI has a value of (15). Additionally, the mitigation console 1502 includes a ranking 1510 for a set of services 1512 that are executing in the partition 1506. The set of services 1512 are candidates for stopping execution of operations in the cloud environment to mitigate an effect of the trigger event 1504 on the cloud infrastructure. In one example, the mitigation console 1502 includes weighting metrics 1514 corresponding to the services 1512. The weighting metrics 1514 may respectively represent a degree of importance, significance, value, or impact of the corresponding services 1512 and/or of the services features respectively associated with the services 1512. Additionally, or alternatively, the mitigation console 1502 may include mitigation factors 1516 corresponding to the services 1512. The mitigation factors 1516 may represent an extent that the trigger event 1504 may be mitigated by stopping a respective service 1512. The mitigation factors 1516 may be compared to the mitigation target 1508 to determine services 1512 for stopping to meet the mitigation target 1508.

In one example, the mitigation console 1502 may include a recommendation 1518 corresponding to the respective services 1512. The recommendation 1518 may indicate whether the system recommends stopping a particular service 1512 and/or whether the system recommends for a particular service 1512 to continue executing in the cloud environment. In one example, the mitigation console 1502 may include one or more selection buttons 1520. A user may interact with the selection buttons 1520 to provide an input that instructs the system to proceed or not proceed with a recommendation 1518.

As shown in FIG. 15, the services 1512 are ranked according to the weighting metric 1514 and displayed in the mitigation console 1502 according to the ranking 1510. Service E has a weighting metric 1514 value of (3) and is ranked first in the ranking, indicating that Service E has a relatively lower value than the other services included in the ranking 1510. Additionally, the mitigation console 1502 indicates that the mitigation factor 1516 for Service E has a value of (2). A comparison of the mitigation factor 1516 for Service B to the mitigation target 1508 of (15) indicates that stopping service E may have a minimal contribution to mitigating an effect of the trigger event on the cloud infrastructure. As shown in FIG. 15, the system recommends continuing execution of Service E in the cloud environment. Additionally, the system recommends stopping Service A. The recommendation 1518 to stop Service A may be based on the weighting metric 1514 for Service A having a relatively lower value (e.g., a value of 3). Additionally, or alternatively, the recommendation 1518 to stop Service A may be based on the mitigation factor 1516 for Service A (a value of 7) indicating that stopping Service B may have an appreciable contribution towards mitigation the effect of the trigger event on the cloud infrastructure. As shown in FIG. 15, a user has selected selection button 1520a to provide an indication to the system to proceed with stopping Service A. Additionally, the recommendation 1518 for Service C indicates that the system recommends stopping Service C. The weighting metric 1514 for Service C has a value of (8). Service C has an alleviation favor of (8), indicating that stopping Service C, together with Service A, meets the mitigation target 1508 (e.g., 7+8=15). Although, as shown in FIG. 15, Service B has a mitigation factor 1516 of (16) that meets the mitigation target 1508 of (15), Service B has a weighting metric 1514 of (14), indicating that Service B has a higher value to the partition 1506 than Service C and Service A combined (e.g., 5+8<14). The recommendation by the system to stop Service C may be based on a combination of the weighting metrics 1514 and the mitigation factors 1516. In one example, the system may recommend stopping Service C, together with Service A, to mitigate the effect of the trigger event on the cloud infrastructure. A user may provide an indication to the system to proceed with stopping Service C by selecting selection button 1520b.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media includes instructions that, when executed by one or more hardware processors, cause performance of any of the operations described herein and/or recited in any of the claims.

In an embodiment, a method includes operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
detecting an occurrence of a trigger event that threatens an operability of at least a portion of a cloud infrastructure of a cloud environment;
executing a mitigation process for mitigating an effect of the trigger event, at least by:
determining a set of candidate services as candidates for stopping execution of operations in the cloud environment;
generating a ranking of the set of candidate services, based at least on weighting metrics associated with respective service features of the set of candidate services;
based at least on the ranking, selecting a first service of the set of candidate services for stopping execution of operations in the cloud environment;
stopping execution of operations of the first service in the cloud environment, to at least partially mitigate the effect of the trigger event;
wherein the method is performed by at least one device including a hardware processor.

2. The method of claim 1, wherein the ranking is further based on weighting metrics associated with the set of candidate services.

3. The method of claim 1, further comprising:
prior to detecting the occurrence of the trigger event: receiving user input that assigns one or more of the weighting metrics associated with respective service features of the set of candidate services.

4. The method of claim 1, wherein the ranking is further based on weighting metrics associated with one or more service features depended upon by one or more services in the set of candidate services.

5. The method of claim 4, wherein generating the ranking comprises:
determining the weighting metrics associated with respective service features of the set of candidate services, based on a dependency graph that graphs dependencies between services and service features in the cloud environment.

6. The method of claim 1, wherein the ranking is further based on operational impact metrics associated with respective service features of the set of candidate services.

7. The method of claim 1, further comprising:
determining a ranking adjustment corresponding to a second service, of the set of candidate services, based on one or more previous occurrences of the second service having been stopped in connection with one or more previous trigger events;
adjusting the ranking based on the ranking adjustment, wherein adjusting the ranking results in one or more of (a) the first service being ranked higher in the ranking than if the ranking had not been adjusted or (b) the second service being ranked lower in the ranking than if the ranking had not been adjusted.

8. The method of claim 1, further comprising:
determining a ranking adjustment corresponding to the first service based on one or more previous occurrences of the first service having not been stopped in response to one or more previous trigger events;
adjusting the ranking based on the ranking adjustment, wherein adjusting the ranking results in one or more of (a) the first service being ranked higher in the ranking than if the ranking had not been adjusted or (b) a second service, of the set of candidate services, being ranked lower in the ranking than if the ranking had not been adjusted.

9. The method of claim 1, wherein:
the cloud environment is provided by a first entity;
the weighting metrics associated with the respective service features of the set of candidate services are provided by a second entity; and
the first entity controls, at least in part, access to the cloud environment by the second entity.

10. The method of claim 9, wherein:
the cloud environment comprises one or more partitions associated with a third entity; and
the second entity controls, at least in part, access to the one or more partitions by the third entity.

11. One or more non-transitory computer-readable media storing instructions that, when executed by one or more hardware processors, cause performance of operations comprising:
detecting an occurrence of a trigger event that threatens an operability of at least a portion of a cloud infrastructure of a cloud environment;
executing a mitigation process for mitigating an effect of the trigger event, at least by:
determining a set of candidate services as candidates for stopping execution of operations in the cloud environment;
generating a ranking of the set of candidate services, based at least on weighting metrics associated with respective service features of the set of candidate services;
based at least on the ranking, selecting a first service of the set of candidate services for stopping execution of operations in the cloud environment;
stopping execution of operations of the first service in the cloud environment, to at least partially mitigate the effect of the trigger event.

12. The one or more non-transitory computer-readable media of claim 11, wherein the ranking is further based on weighting metrics associated with the set of candidate services.

13. The one or more non-transitory computer-readable media of claim 11, wherein the operations further comprise:
prior to detecting the occurrence of the trigger event: receiving user input that assigns one or more of the weighting metrics associated with respective service features of the set of candidate services.

14. The one or more non-transitory computer-readable media of claim 11, wherein the ranking is further based on weighting metrics associated with one or more service features depended upon by one or more services in the set of candidate services.

15. The one or more non-transitory computer-readable media of claim 14, wherein generating the ranking comprises:
determining the weighting metrics associated with respective service features of the set of candidate services, based on a dependency graph that graphs dependencies between services and service features in the cloud environment.

16. The one or more non-transitory computer-readable media of claim 11, wherein the ranking is further based on operational impact metrics associated with respective service features of the set of candidate services.

17. The one or more non-transitory computer-readable media of claim 11, wherein the operations further comprise:
determining a ranking adjustment corresponding to a second service, of the set of candidate services, based on one or more previous occurrences of the second service having been stopped in connection with one or more previous trigger events;
adjusting the ranking based on the ranking adjustment, wherein adjusting the ranking results in one or more of (a) the first service being ranked higher in the ranking than if the ranking had not been adjusted or (b) the second service being ranked lower in the ranking than if the ranking had not been adjusted.

18. The one or more non-transitory computer-readable media of claim 11, wherein the operations further comprise:
determining a ranking adjustment corresponding to the first service based on one or more previous occurrences of the first service having not been stopped in response to one or more previous trigger events;
adjusting the ranking based on the ranking adjustment, wherein adjusting the ranking results in one or more of (a) the first service being ranked higher in the ranking than if the ranking had not been adjusted or (b) a second service, of the set of candidate services, being ranked lower in the ranking than if the ranking had not been adjusted.

19. The one or more non-transitory computer-readable media of claim 11, wherein:
the cloud environment is provided by a first entity;
the weighting metrics associated with the respective service features of the set of candidate services are provided by a second entity; and
the first entity controls, at least in part, access to the cloud environment by the second entity.

20. A system comprising:
at least one device including a hardware processor;
the system being configured to perform operations comprising:
detecting an occurrence of a trigger event that threatens an operability of at least a portion of a cloud infrastructure of a cloud environment;
executing a mitigation process for mitigating an effect of the trigger event, at least by:
determining a set of candidate services as candidates for stopping execution of operations in the cloud environment;
generating a ranking of the set of candidate services, based at least on weighting metrics associated with respective service features of the set of candidate services;
based at least on the ranking, selecting a first service of the set of candidate services for stopping execution of operations in the cloud environment;
stopping execution of operations of the first service in the cloud environment, to at least partially mitigate the effect of the trigger event.
